(19) United States
(12) Patent Application Publication
(10) Pub. No.: US 2024/0371554 A1
(43) Pub. Date: Nov. 7, 2024

(54) MAGNETIC APPARATUSES WITH DIRECTIONAL MAGNETIC FIELDS AND METHODS FOR GENERATING SAME

(71) Applicant: Lantha Tech Ltd., Calgary (CA)

(72) Inventors: Evan Trevors, Austin, TX (US); Nicholas Simin, Calgary, AB (CA); Ross Guitard, Camobellton,NB (CA)

(21) Appl. No.: 18/686,828

(22) PCT Filed: Aug. 24, 2022
(86) PCT No.: PCT/CA2022/051282

§ 371 Date: Feb. 26, 2024

Related U.S. Application Data
(60) Provisional application No. 63/236,354, filed on Aug. 24, 2021.
(60) Provisional application No. 63/255,591, filed on Oct. 14, 2021.
(60) Provisional application No. 63/332,917, filed on Apr. 20, 2022.

(51) Int. Cl. H01F 7/02

(52) U.S. Cl. CPC H01F 7/0273

(57) ABSTRACT

A magnetic unit for generating a directional magnetic field towards a target direction on a front side thereof. The magnetic unit has a pair of front magnetic structures and a rear magnetic structure. Each of the front magnetic structures and the rear magnetic structure has a first pole in a target area about a front edge of a target side. In a first state, the first poles of the front magnetic structures and the rear magnetic structure are a same pole thereby forming a target pole in the target area for engaging a work-piece about the front edge. Each of the front magnetic structures and the rear magnetic structure has a second pole opposite to the respective first pole, the second poles of the front magnetic structures and the rear magnetic structure are on a rear side of the front edge and at a distance thereto.

### CROSS-REFERENCE TO RELATED APPLICATIONS

This application is a 371 national stage application of Patent Cooperation Treaty International Application Ser. No. PCT/CA2022/051282, which claims the benefit of U.S. Provisional Patent Application Ser. Nos. 63/236,354 filed Aug. 24, 2021, 63/255,591 filed Oct. 14, 2021, and 63/332,917 filed Apr. 20, 2022, the content of each of which is incorporated herein by reference in its entirety.

### FIELD OF THE DISCLOSURE

The present disclosure relates generally to magnetic apparatuses and methods, and in particular to magnetic apparatuses with single-pole directional magnetic fields and/or alternating flux induction, and methods for generating same.

### BACKGROUND

Magnetic devices using magnets are known. Generally, magnetism may be simplified into three states: north, south, or null, where null represents a field strength that is too weak to be noticed in a given application. North (N) and south(S) are often referred to as poles, much like that of the Earth's. A magnet is dipole comprising a N pole and a S pole, where the magnetic field or magnetic flux (which is a measurement of the magnetic field) flow outside the magnet from the N pole to the S pole thereof. Opposite poles of a plurality of magnets (that is, N to S and S to N) attract each other, and like poles (that is, N to N and S to S) repel each other.

Hereinafter, the polarity of a magnet (or the magnetization vector thereof) may be defined as the direction from a first pole to a second pole thereof, for example, from S to N. Of course, those skilled in the art will appreciate that the polarity of a magnet may alternatively be defined as from N to S.

Magnetic devices with one-sided magnetic flux (or simply “flux”) or magnetic fields is known. Generally, one-sided flux is achieved by an arrangement of magnets such that the magnetic flux on one side thereof is enhanced and on the opposite side is nearly canceled. In such devices, a magnetic field towards a predefined target direction may be enabled and disabled by switching the relative positions of a plurality of permanent magnets between an ON position and an OFF position.

For example, U.S. Pat. No. 8,256,098 B2 to Michael teaches a method for producing a switchable core element-based permanent magnet apparatus used for holding and lifting a target. The apparatus comprises two or more carrier platters containing core elements. The core elements are magnetically matched soft steel pole conduits attached to the north and south magnetic poles of one or more permanent magnets, inset into carrier platters. The pole conduits contain and redirect the permanent magnets' magnetic field to the upper and lower faces of the carrier platters. By containing and redirecting the magnetic field within the pole conduits, like poles have a simultaneous level of attraction and repulsion. Aligning upper core elements “in-phase,”with the lower core elements, activates the apparatus by redirecting the magnetic fields of both pole conduits into the target. Anti-aligning upper core elements “out-of-phase,” with the lower core elements, deactivates the apparatus resulting in pole conduits containing opposing fields.

U.S. Pat. No. 8,350,663 to Michael teaches a method for creating a device for a rotary switchable multi-core element, permanent magnet-based apparatus for holding or lifting a target. The apparatus comprises of two or more carrier platters, each containing a plurality of complementary first and second core elements. Each core element comprises permanent magnet(s) with magnetically matched soft steel pole conduits attached to the north and south poles of the magnet(s). Core elements are oriented within adjacent carrier platters such that relative rotation allows for alignment in-phase or out-of-phase of the magnetic north and south fields within the pole conduits. Aligning a first core element “in-phase” with a second core element, that is, north-north/south-south, activates that core element pair, allowing the combined magnetic fields of the pole conduits to be directed into a target. Aligning the core element pair “out-of-phase,” that is, north-south/south-north, deactivates that core element pair by containing opposing fields within the pole conduits.

U.S. Pat. No. 9,818,522 B2 to Kocijan teaches a method and device for self-regulated flux transfer from a source of magnetic energy into one or more ferromagnetic work-pieces, wherein a plurality of magnets, each having at least one N-S pole pair defining a magnetization axis, are disposed in a medium having a first relative permeability, the magnets being arranged in an array in which gaps of predetermined distance are maintained between neighboring magnets in the array and in which the magnetization axes of the magnets are oriented such that immediately neighboring magnets face one another with opposite polarities, such arrangement representing a magnetic tank circuit in which internal flux paths through the medium exist between neighboring magnets and magnetic flux access portals are defined between oppositely polarized pole pieces of such neighboring magnets, and wherein at least one working circuit is created which has a reluctance that is lower than that of the magnetic tank circuit bringing one or more of the magnetic flux access portals into close vicinity to or contact with a surface of a ferromagnetic body having a second relative permeability that is higher than the first relative permeability, whereby a limit of effective flux transfer from the magnetic tank circuit into the working circuit will be reached when the work-piece approaches magnetic saturation and the reluctance of the work circuit substantially equals the reluctance of the tank circuit.

FIG. 1A shows a so-called “Halbach array” 10 invented by Klaus Halbach (also see academic paper “One-Sided Fluxes-A Magnetic Curiosity” by J. C. Mallinson, published in IEEE Transactions On Magnetics, vol. Mag-9, No. 4, December 1973). As shown, the Halbach array comprises a series of magnets M1 to M5 extending along an axis X, wherein the magnetization vectors of the magnets rotate 90° (in the same plane) with each successive magnet. Specifically, the magnetization vectors of M1, M3, and M5 are alternating and aligned with the extension axis X, and the magnetization vectors of M1, M3, and M5 are alternating and perpendicular to the extension axis X. The interaction of the magnets M1 to M5 produces one-sided flux on a target side 12.

In an intuitive sense, the magnetic elements M1 and M3 act to “squeeze” the magnetic flux out of the magnet M2 on the target side 12, and “pull” the magnetic flux into the magnet M2 on the opposite side 14. Similarly, the magnetic elements M3 and M5 act to “squeeze” the magnetic flux out of the magnet M4 on the target side 12, and “pull” the magnetic flux into the magnet M4 on the opposite side 14. Such a dual action of “flux squeezing” and “flux pulling” thus generates an enhanced magnetic field on the target side 12, and a reduced or even eliminated magnetic field on the opposite side 14.

A drawback of many prior-art Halbach arrays and other one-sided flux devices is that such devices usually apply both magnetic poles to a work-piece with a small distance between the poles which keeps the flux entering the work-piece to be limited to be near to the device. Moreover, such devices usually generate complicated flux on the target side thereof which therefore does not exhibit single-pole-like characteristics. In other words, the flux on the target side cannot be considered and used as a single-pole magnetic device.

For example, FIG. 1B is a side view of the Halbach array 10 shown in FIG. 1A. While the flux on the target side 12 is complicated, one may intuitively understand that the Halbach array 10 generates a South pole (denoted “(S)” wherein “( )” represents a generated or magnetized pole rather than the magnet pole), and a North pole (N) on the target side 12 adjacent the magnets M2 and M4, respectively.

Such a magnetic device is not suitable for use in scenarios, such as magnetic particle inspection non-destructive testing (MPI-NDT or simply NDT) or degausser (also called demagnetization), requiring application of a single magnetic pole or application of N and S poles spaced apart from each other.

### SUMMARY

According to one aspect of this disclosure, there is provided a magnetic unit for generating a directional magnetic field towards a target direction on a front side thereof, the magnetic unit comprising: a pair of front magnetic structures; and a rear magnetic structure on a rear side of the front magnetic structures; each of the front magnetic structures and the rear magnetic structure comprises a first pole in a target area about a front edge of a target side; in a first state, the first poles of the front magnetic structures and the rear magnetic structure are a same pole thereby forming a target pole in the target area for engaging a work-piece about the front edge; and each of the front magnetic structures and the rear magnetic structure comprises a second pole opposite to the respective first pole, the second poles of the front magnetic structures and the rear magnetic structure are on a rear side of the front edge and at a distance thereto.

In some embodiments, the rear magnetic structure has a polarity aligned with the target direction; and each of the front magnetic structures has a polarity at an angle to the polarity of the rear magnetic structure.

In some embodiments, each of the front magnetic structures has a polarity at an angle α to a polarity of the rear magnetic structure; and 0°<α<180°, 30°<α<180°, 60°<α<180°, 0°<α<90°, 30°<α<90°, 60°<α<90°, or α=90°.

In some embodiments, the first pole of the rear magnetic structure extends to the front edge.

In some embodiments, the first poles of the front magnetic structures are spaced from the front edge.

In some embodiments, the first poles of the front magnetic structures extend to the front edge.

In some embodiments, the target area comprises one or more ferromagnetic pieces magnetically engaging the first poles of the front magnetic structures and the rear magnetic structure.

In some embodiments, the target side is beside a plane defined by the front magnetic structures; wherein the target side is a radially outer side of the magnetic unit; or wherein the target side is a radially inner side of the magnetic unit.

In some embodiments, in a second state, the first pole of the rear magnetic structure is different to the first poles of the front magnetic structures thereby cancelling the target pole in the target area.

In some embodiments, at least one of the rear magnetic structure and the front magnetic structures are rotatable for rotating the polarities thereof to switch the magnetic unit between the first and second states.

In some embodiments, the magnetic unit further comprises an actuation structure for rotating the polarities thereof to switch the magnetic unit between the first and second states.

According to one aspect of this disclosure, there is provided a switchable magnetic unit having opposite first and second sides along a longitudinal direction, the switchable magnetic apparatus comprising: at least one stationary magnet having a polarity along the longitudinal direction; and at least one rotatable magnetic structure on a lateral side of the at least one stationary magnet and rotatable between an ON position and an OFF position, the at least one rotatable magnetic structure comprising at least one rotatable magnet; when the at least one rotatable magnetic structure is at the ON position, a polarity thereof is aligned with the polarity of the at least one stationary magnet thereby forming a first pole on the first side of the switchable magnetic apparatus for generating magnetic flux therefrom; and when the at least one rotatable magnetic structure is at the OFF position, the polarity thereof is opposite to the polarity of the at least one stationary magnet thereby cancelling the first pole and the magnetic flux generated therefrom.

In some embodiments, the switchable magnetic unit further comprises a plurality of ferromagnetic flux guides longitudinally sandwiching the at least one stationary magnet and the at least one rotatable magnetic structure therebetween.

In some embodiments, the switchable magnetic unit further comprises at least one actuation-resistance-reduction magnet on the second side of the at least one rotatable magnet for reducing the resistance during rotation of the at least one rotatable magnet.

In some embodiments, the switchable magnetic unit further comprises a first ferromagnetic component sandwiched between the at least one actuation-resistance-reduction magnet and the at least one rotatable magnet.

In some embodiments, the rotatable magnetic structure further comprises: a pair of rotatable ferromagnetic flux guides coupled to poles of the rotatable magnet and rotatable therewith.

According to one aspect of this disclosure, there is provided a magnetic unit comprising: a first magnetic component having a polarity along a longitudinal direction; the first magnetic component is configured for repeatedly applying a first pole on a first target side along the longitudinal direction and cancelling the first pole on the first target side at a frequency.

In some embodiments, the frequency is adjustable.

In some embodiments, the frequency is adjustable to increase for increasing a strength of magnetic flux applied by the magnetic apparatus to a work-piece on the first target side, and is adjustable to decrease for decreasing the strength of the magnetic flux applied by the magnetic apparatus to the work-piece.

In some embodiments, the frequency is adjustable for adjusting a depth of magnetic flux applied by the magnetic apparatus in a work-piece on the first target side.

In some embodiments, the frequency is adjustable to increase for decreasing a depth of magnetic flux applied by the magnetic apparatus in a work-piece, and is adjustable to decrease for increasing the depth of the magnetic flux applied by the magnetic apparatus to the work-piece.

In some embodiments, the first magnetic component is configured for repeatedly switching the first pole and a second pole on the first target side at the frequency, the second pole being opposite to the first pole.

In some embodiments, the first magnetic component is also configured for repeatedly switching the first pole and a second pole on a second target side at the frequency, the second target side being opposite to the first target side.

In some embodiments, the magnetic unit further comprises a second magnetic component on a lateral side of the first magnetic component; a polarity of the second magnetic component is aligned with a polarity of the first magnetic component when the first pole is applied on the first target side.

In some embodiments, the first magnetic component is rotatable for repeatedly apply the first pole on the first target side and cancelling the first pole on the first target side at the frequency.

In some embodiments, the magnetic unit further comprises a driving component for driving the first magnetic component to repeatedly apply the first pole on the first target side and cancelling the first pole on the first target side at the frequency.

In some embodiments, the first magnetic component comprises a permanent magnet; and the driving component is configured for rotating the first magnetic component to repeatedly apply the first pole on the first target side and cancelling the first pole on the first target side at the frequency.

In some embodiments, the first magnetic component comprises an electromagnetic structure; and the driving component is configured for applying an alternating current to the electromagnetic structure to repeatedly apply the first pole on the first target side and cancelling the first pole on the first target side at the frequency.

According to one aspect of this disclosure, there is provided a magnetic unit comprising: one or more magnetic components switchable between an ON state and an OFF state; the one or more magnetic components in the ON state are configured for applying a magnetic field on a target side thereof; the one or more magnetic components in the OFF state are configured for cancelling the magnetic field on the target side thereof; and the one or more magnetic components are configured for repeatedly switching between the ON state and the OFF state at a frequency.

According to one aspect of this disclosure, there is provided a magnetic apparatus comprising: one or more magnetic units as described above.

According to one aspect of this disclosure, there is provided a magnetic apparatus comprising: a first magnetic unit for forming the first pole; and a second magnetic unit spaced apart from the first magnetic apparatus for forming a second pole opposite to the first pole; at least one of the first and second magnetic apparatus is the magnetic apparatus as described above.

In some embodiments, the magnetic apparatus further comprise at least one second ferromagnetic component connecting the first and second magnetic units.

Other aspects and embodiments of the disclosure are evident in view of the detailed description provided herein.

### BRIEF DESCRIPTION OF THE DRAWINGS

These and other features of the present disclosure will become more apparent in the following detailed description in which reference is made to the appended drawings. The appended drawings illustrate one or more embodiments of the present disclosure by way of example only and are not to be construed as limiting the scope of the present disclosure.

FIG. 1A is a schematic perspective view of a prior-art magnetic apparatus;

FIG. 1B is a schematic side view of the prior-art magnetic apparatus shown in FIG. 1A;

FIGS. 2A and 2B are schematic side views of a single-pole magnetic apparatus according to some embodiments of the present disclosure, wherein the magnetic apparatus comprises a front layer and a rear layer, and wherein the magnetic apparatus is switchable between an ON state (FIG. 2A) and an OFF state (FIG. 2B) by rotating the magnet of the rear layer;

FIGS. 3A and 3B are schematic side views of a single-pole magnetic apparatus according to yet some embodiments of the present disclosure, wherein the magnetic apparatus comprises a front layer and a rear layer, and wherein the magnetic apparatus is switchable between an ON state (FIG. 3A) and an OFF state (FIG. 3B) by rotating the magnets of the front layer;

FIGS. 4A and 4B are schematic side views of a single-pole magnetic apparatus according to still some embodiments of the present disclosure, wherein the magnetic apparatus comprises a front layer and a rear layer, and wherein the magnetic apparatus is switchable between an ON state (FIG. 4A) and an OFF state (FIG. 4B) by rotating the magnet of the rear layer;

FIGS. 5A and 5B are schematic side views of a single-pole magnetic apparatus according to some embodiments of the present disclosure, wherein the magnetic apparatus comprises a front layer and a rear layer, and wherein the magnetic apparatus is switchable between an ON state (FIG. 5A) and an OFF state (FIG. 5B) by rotating the magnets of the front layer;

FIGS. 6A and 6B are conceptual representations of the single-pole magnetic apparatuses shown in FIGS. 2A to 5B in the ON state;

FIG. 6C is a conceptual representation of the single-pole magnetic apparatus according to some embodiments of this disclosure;

FIGS. 7A to 7C are schematic side views of a magnetic apparatus, according to various embodiments of the present disclosure;

FIGS. 8A and 8B are schematic side views of a magnetic apparatus in the ON state (FIG. 8A) and the OFF state (FIG. 8B), according to some embodiments of the present disclosure, wherein the magnetic apparatus comprises a plurality of magnetic units arranged in a planar surface, each magnetic unit similar to the magnetic apparatus shown in FIGS. 4A and 4B;

FIGS. 9A and 9B are schematic side views of a magnetic apparatus in the ON state (FIG. 9A) and the OFF state (FIG. 9B), according to some embodiments of the present disclosure, wherein the magnetic apparatus comprises a plurality of magnetic units arranged in a planar surface, each magnetic unit similar to the magnetic apparatus shown in FIGS. 2A and 2B;

FIGS. 10A and 10B are schematic side views of a magnetic apparatus in the ON state (FIG. 10A) and the OFF state (FIG. 10B), according to some embodiments of the present disclosure, wherein the magnetic apparatus comprises a plurality of magnetic units arranged in a planar surface, each magnetic unit similar to the magnetic apparatus shown in FIGS. 3A and 3B;

FIG. 11 is a schematic perspective view of a magnetic particle inspection non-destructive testing (MPI-NDT) device comprising a pair of magnetic apparatuses as shown in FIGS. 2A to 10B, according to some embodiments of the present disclosure;

FIGS. 12A and 12B are schematic plan views of a magnetic apparatus in the ON state (FIG. 12A) and the OFF state (FIG. 12B), according to some embodiments of the present disclosure, wherein the magnetic apparatus comprises a plurality of magnetic units arranged in a curved surface for generating a directional magnetic field on the exterior side thereof, each magnetic unit similar to the magnetic apparatus shown in FIGS. 4A and 4B;

FIGS. 13A and 13B are schematic plan views of a magnetic apparatus in the ON state (FIG. 13A) and the OFF state (FIG. 13B), according to some embodiments of the present disclosure, wherein the magnetic apparatus comprises a plurality of magnetic units arranged in a curved surface for generating a directional magnetic field on the exterior side thereof, each magnetic unit similar to the magnetic apparatus shown in FIGS. 5A and 5B;

FIGS. 14A and 14B are schematic plan views of a magnetic apparatus in the ON state (FIG. 14A) and the OFF state (FIG. 14B), according to some embodiments of the present disclosure, wherein the magnetic apparatus comprises a plurality of magnetic units arranged in a curved surface for generating a directional magnetic field on the interior side thereof, each magnetic unit similar to the magnetic apparatus shown in FIGS. 4A and 4B;

FIG. 15 is a schematic perspective view of a degausser comprising a magnetic apparatus shown in FIGS. 2A to 14B, according to some embodiments of the present disclosure;

FIG. 16 is a schematic side view of a magnetic apparatus in the ON state, according to some embodiments of the present disclosure;

FIGS. 17A and 17B are schematic perspective views of a magnetic apparatus according to some embodiments of this disclosure, wherein FIG. 17A show the magnetic apparatus in an ON state and FIG. 17B shows the magnetic apparatus in an OFF state;

FIGS. 18A and 18B are schematic perspective views of a magnetic apparatus with reduced switching resistance, according to yet some embodiments of this disclosure, wherein FIG. 18A show the magnetic apparatus in an ON state and FIG. 18B shows the magnetic apparatus in an OFF state;

FIGS. 19A and 19B are schematic perspective views of a magnetic apparatus with rotatable ferromagnetic flux guides, according to still some embodiments of this disclosure, wherein FIG. 19A show the magnetic apparatus in an ON state and FIG. 19B shows the magnetic apparatus in an OFF state;

FIG. 20 is a schematic perspective view of a magnetic particle tester having two magnetic apparatuses shown in FIGS. 19A and 19B, wherein two magnetic apparatuses are connected by a ferromagnetic component and apply opposite poles to a work-piece in the ON state;

FIG. 21 is a schematic perspective view of an alternating flux induction magnetic apparatus, according to some embodiments of this disclosure;

FIG. 22 is a plot showing the test results of an alternating flux induction magnetic apparatus as shown in FIG. 21;

FIG. 23 is a plot showing the test results of another alternating flux induction magnetic apparatus as shown in FIG. 21;

FIG. 24 is a schematic perspective view of an alternating flux induction magnetic apparatus, according to some other embodiments of this disclosure;

FIG. 25A is a schematic perspective view of a magnetic particle tester having a first, alternating flux induction magnetic apparatus shown in FIG. 21 and a second magnetic apparatus for applying opposite poles to a work-piece, according to some embodiments of this disclosure;

FIG. 25B is a schematic perspective view of a magnetic particle tester having two alternating flux induction magnetic apparatuses shown in FIG. 21 for applying opposite poles to a work-piece, according to some other embodiments of this disclosure;

FIG. 26 is a schematic side view of an alternating flux induction magnetic apparatus according to some embodiments of this disclosure;

FIG. 27 is a schematic side view of an alternating flux induction magnetic apparatus according to some other embodiments of this disclosure;

FIG. 28 is a schematic side view of an alternating flux induction magnetic apparatus according to yet some other embodiments of this disclosure;

FIG. 29 is a schematic side view of an alternating flux induction magnetic apparatus according to still some other embodiments of this disclosure;

FIG. 30 is a schematic side view of an alternating flux induction magnetic apparatus according to some embodiments of this disclosure;

FIG. 31 is a schematic side view of an alternating flux induction magnetic apparatus according to some other embodiments of this disclosure;

FIG. 32 is a schematic diagram showing an alternating flux induction magnetic apparatus having an electromagnetic component, according to some other embodiments of this disclosure;

FIGS. 33A to 33D of an alternating flux induction magnetic apparatus having an electromagnetic component, according to some other embodiments of this disclosure;

FIG. 34A is a schematic plan view of an alternating flux induction magnetic apparatus having a rotatable magnetic component, according to some other embodiments of this disclosure, wherein the rotatable magnetic component is in an ON position;

FIG. 34B is a schematic plan view of an alternating flux induction magnetic apparatus shown in FIG. 34A, wherein the rotatable magnetic component is in an OFF position;

FIG. 34C is a schematic plan view of an alternating flux induction magnetic apparatus shown in FIG. 34A, wherein the rotatable magnetic component is in another ON position;

FIG. 34D is a schematic plan view of an alternating flux induction magnetic apparatus shown in FIG. 34A, wherein the rotatable magnetic component is in another OFF position;

FIG. 35 is a schematic side view of a magnetic particle tester having a magnetic apparatus shown in FIG. 34A for applying opposite poles to a work-piece, wherein the rotatable magnetic component of the magnetic apparatus is in an ON position;

FIG. 36A is a schematic plan view of an alternating flux induction magnetic apparatus having a rotatable magnetic component, according to some other embodiments of this disclosure, wherein the rotatable magnetic component is in an ON position;

FIG. 36B is a schematic plan view of an alternating flux induction magnetic apparatus shown in FIG. 36A, wherein the rotatable magnetic component is in an OFF position;

FIG. 36C is a schematic plan view of an alternating flux induction magnetic apparatus shown in FIG. 36A, wherein the rotatable magnetic component is in another ON position;

FIG. 36D is a schematic plan view of an alternating flux induction magnetic apparatus shown in FIG. 36A, wherein the rotatable magnetic component is in another OFF position; and

FIG. 37 is a schematic side view of a magnetic particle tester having a magnetic apparatus shown in FIG. 36A for applying opposite poles to a work-piece, wherein the rotatable magnetic component of the magnetic apparatus is in an ON position.

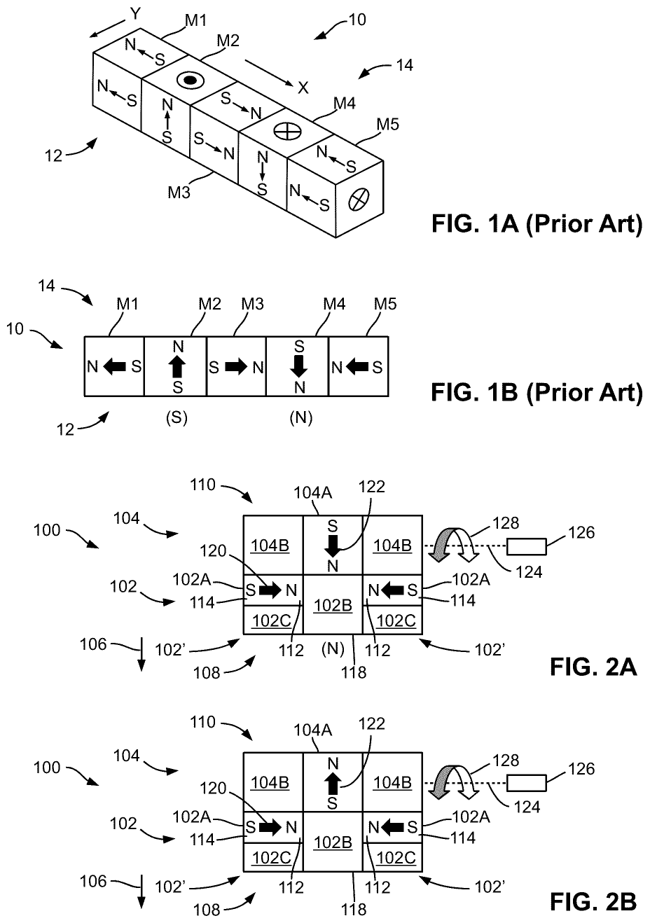

### DETAILED DESCRIPTION

Embodiments of the present disclosure will now be described with reference to FIG. 2A through FIG. 31, which show non-limiting embodiments of a magnetic apparatus. Those skilled in the art will appreciate that different features of various embodiments described in this disclosure may be combined.

In the following, various embodiments of a magnetic apparatus are disclosed. In some embodiments, the magnetic apparatus applies one pole to a ferromagnetic work-piece (simply denoted a “work-piece” hereinafter). In some embodiments, a plurality (such as two) of the magnetic apparatuses may be used as the magnetic components of a device or apparatus for applying opposite poles to a work-piece at spaced-apart positions thereof in order to extend magnetic flux through the work-piece for a large distance between the opposite poles.

In some embodiments, the magnetic apparatus may be switchable between an ON and OFF state, and in the ON state, the magnetic apparatus applies one pole to a work-piece.

FIGS. 2A and 2B are schematic side views of a magnetic apparatus 100 according to some embodiments of the present disclosure. The magnetic apparatus 100 comprises a front layer 102 and a rear layer 104 on the rear side 110 of the front layer 102 and in contact or in close proximity therewith. As will be described in more detail below, the front and rear layers 102 and 104 comprise a plurality of magnets and may further comprise one or more ferromagnetic flux guides. As those skilled in the art will appreciate, the magnets disclosed herein may be made of any suitable magnetic materials. For example, in some embodiments, the magnets disclosed herein may be N52-grade magnets with rectangular cross-sections. In some other embodiments, the magnets disclosed herein may comprise other permanent magnet materials such as NdFEB, NiCo, and/or the like. In some other embodiments, the magnets disclosed herein may be electromagnets.

The one or more ferromagnetic flux guides may be made of any suitable ferromagnetic material such as steel.

Those skilled in the art will also appreciate that, in the magnetic apparatus 100, the neighboring magnets and the neighboring magnets and ferromagnetic flux guides are preferably in contact with each other or in close proximity with each other for preventing significant loss of magnetic flux.

In these embodiments, the magnetic apparatus 100 is switchable between an ON state and an OFF state. The front and rear layers 102 and 104 may be configured such that, when in an ON state (FIG. 2A), the magnetic apparatus 100 generates or activates a single-pole (for example, the N pole (N) shown in FIG. 2A) directional magnetic field along a target direction 106 on a target side 108 thereof (which in these embodiments is the front side of the magnetic apparatus 100), and, when in an OFF state (FIG. 2B), the magnetic apparatus 100 removes or deactivates the single-pole directional magnetic field at least at the target side 108 thereof.

Herein, the target direction 106 is generally perpendicular to the front and rear layers 102 and 104. In embodiments wherein the front and rear layers 102 and 104 are flat layers (that is, they are defined on respective planes or planar surfaces), the target direction 106 at one location of the magnetic apparatus 100 is generally parallel to the target direction 106 at any other location thereof. In embodiments wherein the front and rear layers 102 and 104 are curved layers (that is, they are defined on respective surfaces such as cylindrical surfaces, spherical surfaces, and/or the like), the target direction 106 is generally a radial direction (inward or outward depending on the curvatures of the front and rear layers 102 and 104), and the target direction 106 at one location of the magnetic apparatus 100 may not be parallel to the target direction 106 at another location thereof.

As shown in FIGS. 2A and 2B, the front layer 102 comprises a pair of front-layer magnet assemblies 102′ sandwiching therebetween a ferromagnetic flux guide 102B (also denoted a “ferromagnetic block” without referring specific shapes thereof).

Each front-layer magnet assembly 102′ comprises a front-layer magnet 102A and a non-ferromagnetic block 102C on the front side 108 of the front-layer magnet 102A. As those skilled in the art will appreciate, the non-ferromagnetic blocks disclosed herein, such as the non-ferromagnetic blocks 102C and the non-ferromagnetic blocks 104B (described in more detail later), may be made of any suitable non-ferromagnetic materials such as aluminum, plastic, or simply empty space (for example, air gaps or vacuum).

The front-layer magnets 102A of the front-layer magnet assemblies 102′ are in an end-to-end arrangement such that for the pair of the front-layer magnets 102A, a pair of the ends or poles 112 (denoted proximal ends or poles) are adjacent to each other and are at a distance smaller than that of the other pair of the ends or poles 114 thereof (denoted distal ends or poles). More specifically, the angle between the polarities of the front-layer magnets 102A with respect to the ferromagnetic block 102B therebetween is greater than 0° and smaller than 90°.

In these embodiments, each front-layer magnet 102A has a uniform thickness from the proximal pole 112 to the distal pole 114 which is smaller than that of the ferromagnetic block 102B. Therefore, the distal pole 114 thereof is on the rear side of the front edge 118 of magnetic apparatus 100 (or more specifically the front edge of the ferromagnetic block 102B) and at a distance thereto. Moreover, the front-layer magnets 102A are oriented with reversed polarities or magnetization vectors 120 such that the ferromagnetic block 102B is adjacent to the same poles (being either the N pole or the S pole) of the front-layer magnets 102A in both the ON state and the OFF state.

The rear layer 104 comprises a rear-layer magnet 104A sandwiched between two non-ferromagnetic blocks 104B. The rear-layer magnet 104A overlaps the ferromagnetic block 102B along the target direction 106 and has a polarity or magnetization vector 122 aligned with the target direction 106. The non-ferromagnetic blocks 104B overlap respective front-layer magnets 102A along the target direction 106.

In these embodiments, the magnetic apparatus 100 may be switched between the ON and OFF states by rotating the rear layer 104 or the rear-layer magnet 104A thereof (indicated by the arrow 128) about an axis 124 perpendicular to the polarity 122 thereof to reverse the polarity direction of the rear-layer magnet 104A.

In particular, the magnetic apparatus 100 is in the ON state when the ferromagnetic block 102B is adjacent the same poles of the front-layer magnets 102A and rear-layer magnet 104A. For example, as shown in FIG. 2A, the ferromagnetic block 102B is adjacent the N poles of the front-layer magnets 102A and rear-layer magnet 104A. Intuitively, the N pole of the rear-layer magnet 104A “squeezes” the flux of the N poles of the front-layer magnets 102A out of the target side 108 along the target direction 106, thereby generating a N pole (N) on the target side 108. Moreover, as the distal S poles 114 are at a distance to the front edge 118 of the magnetic apparatus 100, and as the magnetic field strength is inversely proportional to the cube of the distance, the effect of the distal S poles 114 to the object (not shown) on the target side 108 may be omitted. Therefore, the magnetic apparatus 100 generates a single N pole magnetic flux on the target side 108 in the ON state.

The magnetic apparatus 100 is in the OFF state when the pole of the rear-layer magnet 104A adjacent the ferromagnetic block 102B is different to the poles of the front-layer magnets 102A adjacent the ferromagnetic block 102B. For example, as shown in FIG. 2B, the S pole of the rear-layer magnet 104A is adjacent the ferromagnetic block 102B while the N poles of the front-layer magnets 102A are adjacent the ferromagnetic block 102B. Intuitively, the S pole of the rear-layer magnet 104A “pulls” the flux of the N poles of the front-layer magnets 102A away from the target side 108 thereby substantively reducing or even or eliminating the magnetic flux on the target side 108. In the embodiments where the magnetic apparatus 100 in the ON state is used for engaging a ferromagnetic work-piece (not shown) on the target side, when the magnetic apparatus 100 is switched to the OFF state, a substantively reduced magnetic force (or effectively zero magnetic force) is applied to the work-piece 114 such that the work-piece 114 may be released from the magnetic apparatus 100.

In some embodiments, the magnetic apparatus 100 also comprises an actuation structure 126 for switching the magnetic apparatus 100 to between the ON and OFF states. The actuation structure 126 may be any suitable actuation structure such as a manual actuation structure, a motor, an electrical actuation structure, or the like.

For example, in some embodiments, the magnets 102A and/or 104A are electromagnets and the actuation structure comprises one or more electromagnet controllers for changing the polarities of the magnets 102A and/or 104A by changing the direction of the current thereof.

In some other embodiments, the actuation structure comprises actuators for moving and/or rotating the magnets 102A and/or 104A to change polarities thereof. The actuation may be conducted on the rear layer 104, the front layer 102, or a combination thereof. The actuation mechanism may include a housing to constrain the stationary magnets 102A/104A while linearly positioning, rotationally positioning, or rotating in position the actuated magnets. The actuation may be powered manually using a mechanical component such as a lever, electrically controlled using a device such as an electric motor, pneumatically controlled, or controlled by a combustion engine.

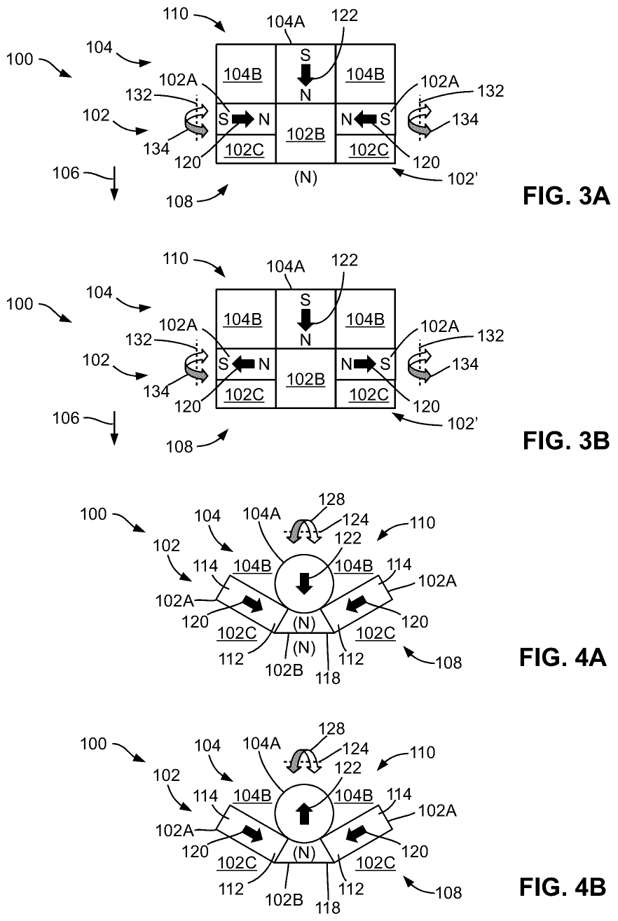

In some embodiments as shown in FIGS. 3A and 3B, the magnetic apparatus 100 may be switched between the ON state (FIG. 3A) and the OFF state (FIG. 3B) by rotating each front-layer magnet 102A (indicated by the arrow 134) about an axis 132 perpendicular to the polarity 120 thereof to reverse the polarity direction thereof.

FIGS. 4A and 4B show the magnetic apparatus 100 in some embodiments. The magnetic apparatus 100 in these embodiments is similar to that shown in FIGS. 2A and 2B except that, in these embodiments, the proximal pole 112 of each front-layer magnet 102A is adjacent the front edge 118 of the magnetic apparatus 100 and fully engages the ferromagnetic block 102B, thereby allowing the magnetic apparatus 100 in these embodiments to generate further-enhanced single-pole magnetic flux on the target side 108 compared to that shown in FIGS. 2A and 2B. In FIGS. 4A and 4B, the magnetic apparatus 100 are switched ON (FIG. 4A) and OFF (FIG. 4B) by rotating the rear-layer magnet 104A (indicated by the arrow 128) about an axis 124 perpendicular to the polarity 122 thereof.

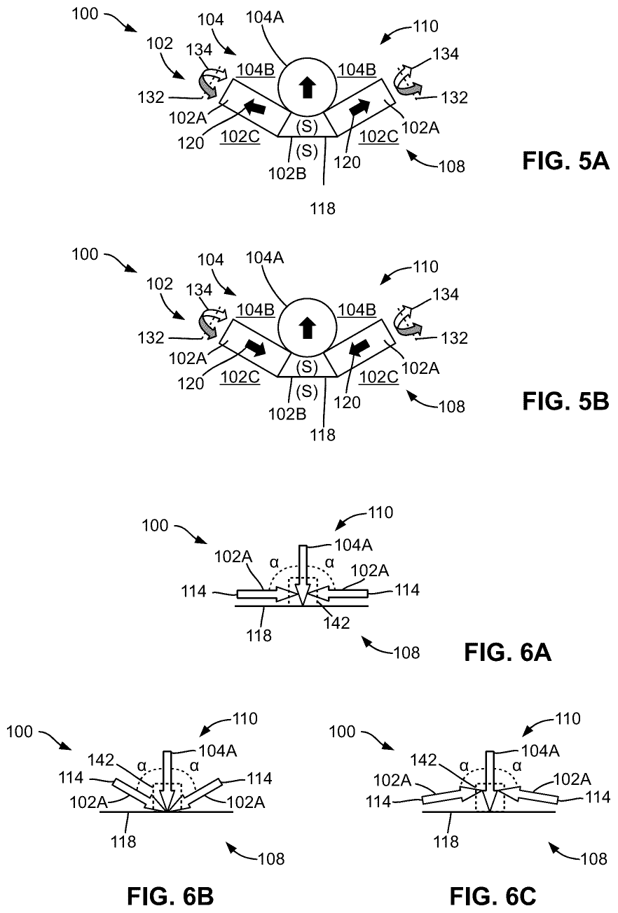

FIGS. 5A and 5B show the magnetic apparatus 100 in some embodiments. The magnetic apparatus 100 in these embodiments is similar to that shown in FIGS. 4A and 4B except that, in these embodiments, the magnetic apparatus 100 is switched ON and generates a S pole (FIG. 5A) and switched OFF (FIG. 5B) by rotating each front-layer magnet 102A (indicated by the arrow 134) about an axis 132 perpendicular to the polarity 120 thereof to reverse the polarity direction thereof.

The magnetic apparatus 100 described above may be generally represented as shown in FIGS. 6A and 6B (both showing the ON state thereof). As shown, the magnetic apparatus 100 generally comprises two front-layer magnetic structures and one rear-layer magnetic structure (represented by the polarity arrows 102A and 104A). Each of the front-layer magnetic structures and the rear-layer magnetic structure comprises a first, proximal pole (represented by the heads of the polarity arrows 102A and 104A) in a target area 142 on a target side 108. In the ON state, the first poles of the front-layer magnetic structures 102A and the rear-layer magnetic structure 104A are a same pole thereby forming the same pole (denoted a “target pole”) in the target area 142 adjacent the front edge 118 of the target side 108 for engaging a work-piece (not shown). Moreover, each of the front-layer magnetic structures 102A and the rear-layer magnetic structure 104A comprises a second, distal pole (represented by the tails of the polarity arrows 102A and 104A) opposite to the respective first pole, the second poles of the front-layer magnetic structures 102A and the rear-layer magnetic structure 104A are on the rear side of the front edge 118 of the target side 108 and at a distance thereto (and thus at a distance to the formed target pole).

As shown in FIGS. 6A to 6C, in various embodiments, the angle α between each front-layer magnetic structure 102A and the rear-layer magnetic structure 104A is within a range satisfying any one of a greater than 0°, α greater than 30°, and α greater than 60°, and satisfying any one of α smaller than 180° and α smaller than or equal to 90°. For example, the angle α in various embodiments may be 0°<α<180°, 30°<α<180°, 60°<α<180°, 0°<α<90°, 30°<α<90°, 60°<α<90°, or α=90°.

In various embodiments, each of the front-layer and rear-layer magnetic structures 102A and 104A may comprise one or more magnetic components and may further comprise one or more ferromagnetic components. For example, the portions of the front-layer and rear-layer magnetic structures 102A and 104A in the target area 142 may be magnetic components, ferromagnetic components, or a ferromagnetic component shared by the front-layer and rear-layer magnetic structures 102A and 104A.

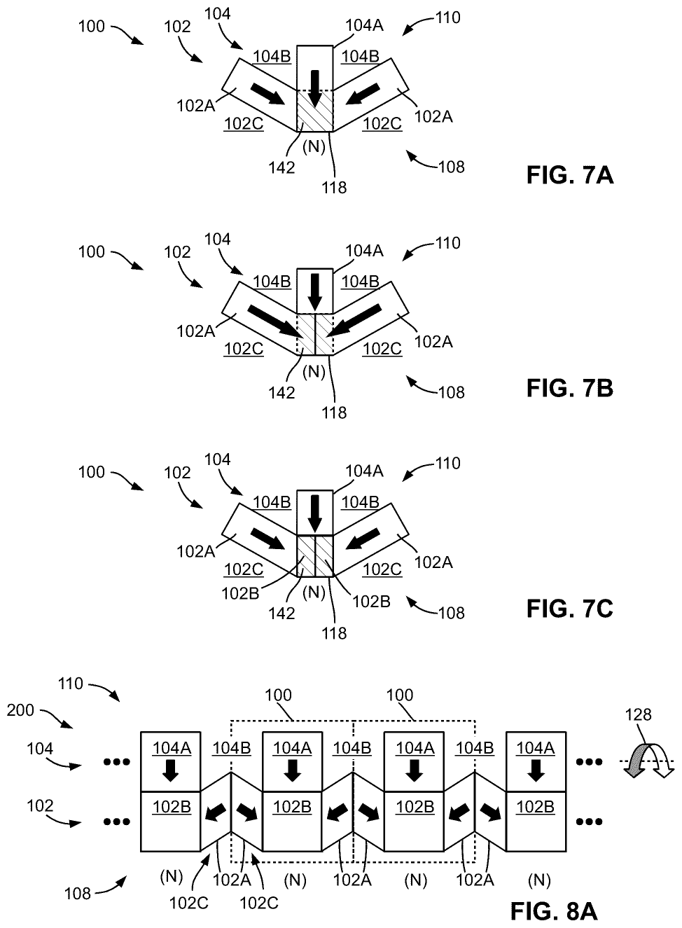

For example, FIG. 7A shows a magnetic apparatus 100, wherein the magnetic apparatus 100 does not comprise any ferromagnetic component. The rear-layer magnet 104A extends into the target area 142 to the front edge 118.

In the example shown in FIG. 7B, the magnetic apparatus 100 does not comprise any ferromagnetic component. The two front-layer magnets 102A extend into the target area 142 and form the front edge 118.

In the example shown in FIG. 7C, the magnetic apparatus 100 comprises two ferromagnetic flux guides 102B in the target area 142 and form the front edge 118.

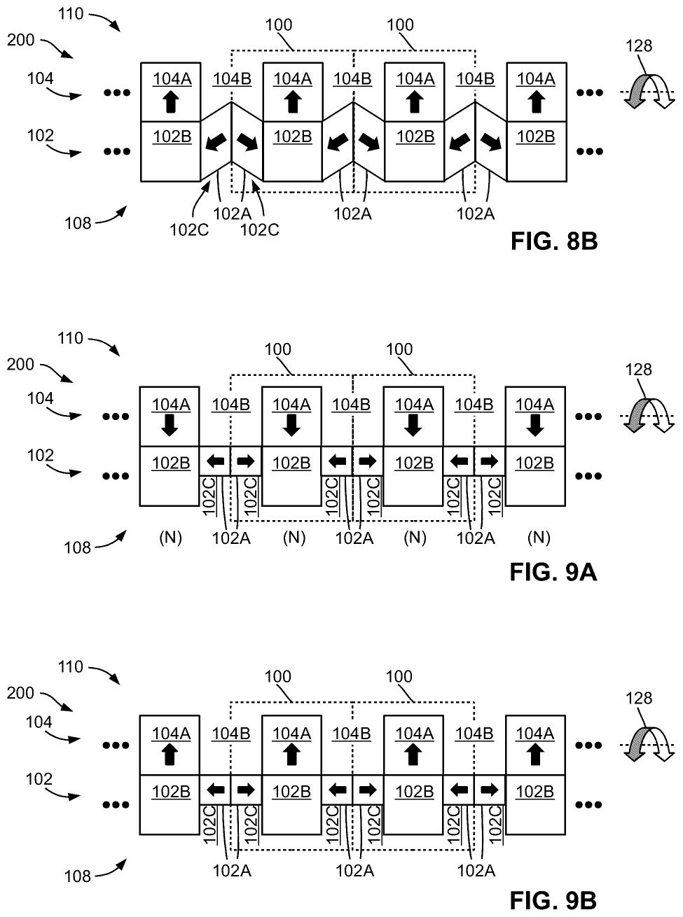

In some embodiments as shown in FIGS. 8A and 8B, a magnetic apparatus 200 may comprise a plurality of magnetic apparatuses 100 (denoted magnetic units 100 hereinafter) similar to that shown in FIGS. 4A and 4B.

In some embodiments as shown in FIGS. 9A and 9B, a magnetic apparatus 200 may comprise a plurality of magnetic units 100 similar to that shown in FIGS. 2A and 2B.

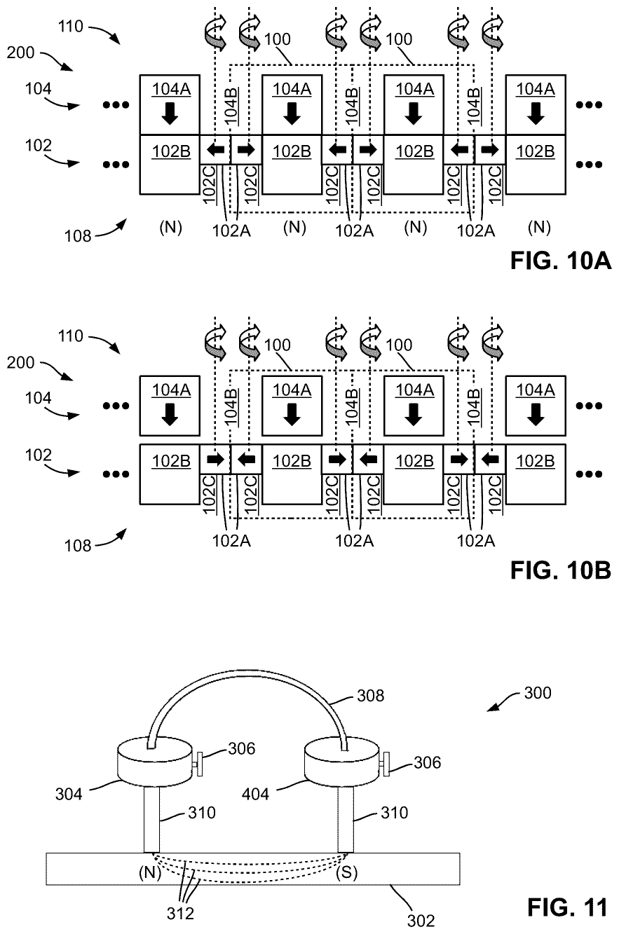

In some embodiments as shown in FIGS. 10A and 10B, a magnetic apparatus 200 may comprise a plurality of magnetic units 100 similar to that shown in FIGS. 3A and 3B.

The magnetic apparatus 100 or 200 shown in FIGS. 2A to 10B may be used in many applications. For example, FIG. 11 shows a magnetic particle inspection non-destructive testing (MPI-NDT) device 300 for identifying defects in a ferromagnetic work-piece 302. The MPI-NDT device 300 comprises a pair of magnetic apparatuses 304 each of which may be above-described magnetic apparatuses 100 or 200 and comprise an actuator 306 for switching the magnetic apparatuses 304 ON and OFF. The magnetic apparatuses 304 are coupled together at the rear sides thereof by a ferromagnetic link 308.

The magnetic apparatuses 304 are configured for engaging the ferromagnetic work-piece 302 via respective ferromagnetic flux guides 310 at positions spaced from each other, and generate one or more N poles and one or more S poles at the respective positions. The magnetic flux 312 then flows from the N pole to the S pole inside the ferromagnetic work-piece 302. A use may spread ferromagnetic particles on the surface of the ferromagnetic work-piece 302. If the ferromagnetic work-piece 302 has any defects, the ferromagnetic particles may aggregate about the positions of the defects. Thus, a visional inspect may easily identify the defects.

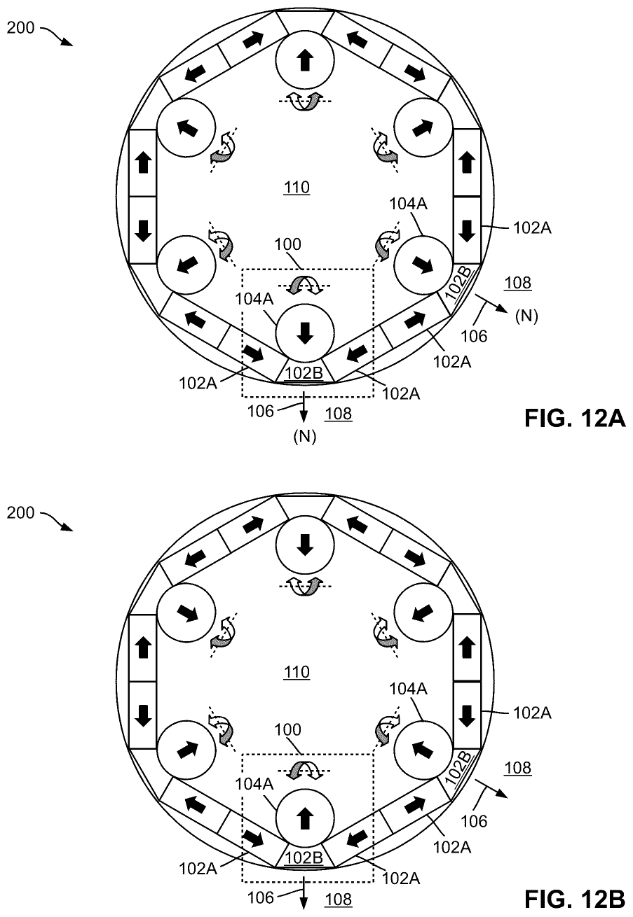

In the embodiments shown in FIGS. 8A to 10B, the front and rear layers 102 and 104 are defined on respective planes and, for example, in the form of plates. In some embodiments shown in FIGS. 12A and 12B, the front and rear layers 102 and 104 may be defined on respective curved surfaces and, for example, in the form of concentric cylinders or spheres, wherein the target direction 106 comprises radially outward directions and the target side 108 is the exterior side of the magnetic apparatus 200.

FIGS. 12A and 12B show magnetic apparatus 200 in some embodiments, wherein the front and rear layers 102 and 104 may be defined on respective curved surfaces and, for example, in the form of concentric cylinders or spheres. The target direction 106 comprises radially outward directions and the target side 108 is the exterior side of the magnetic apparatus 200.

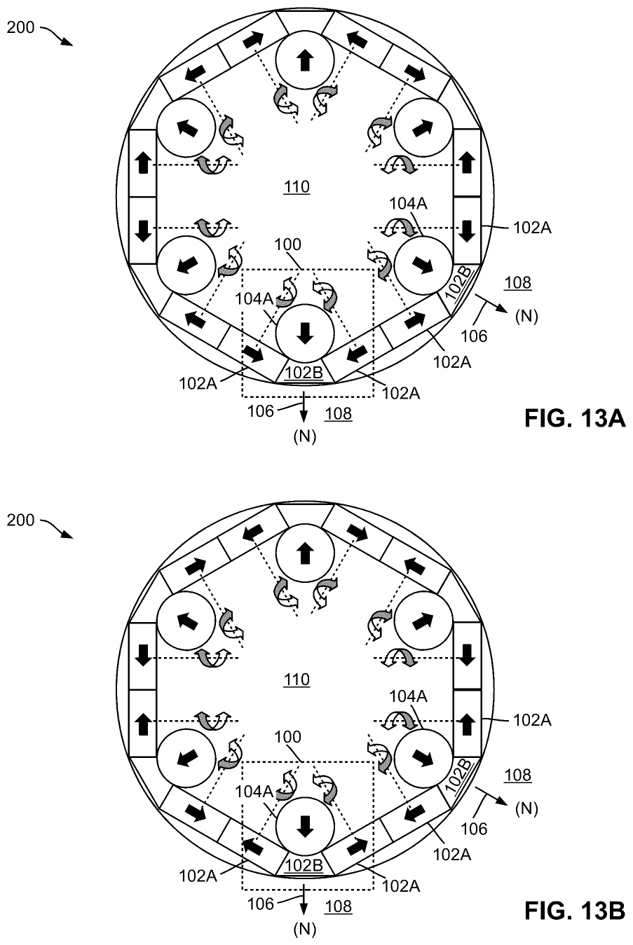

FIGS. 13A and 13B show a magnetic apparatus 200 similar to that shown in FIGS. 12A and 12B except that in the embodiments shown in FIGS. 13A and 13B, the magnetic apparatus 200 is turned ON and OFF by rotating the front layer magnets 102A.

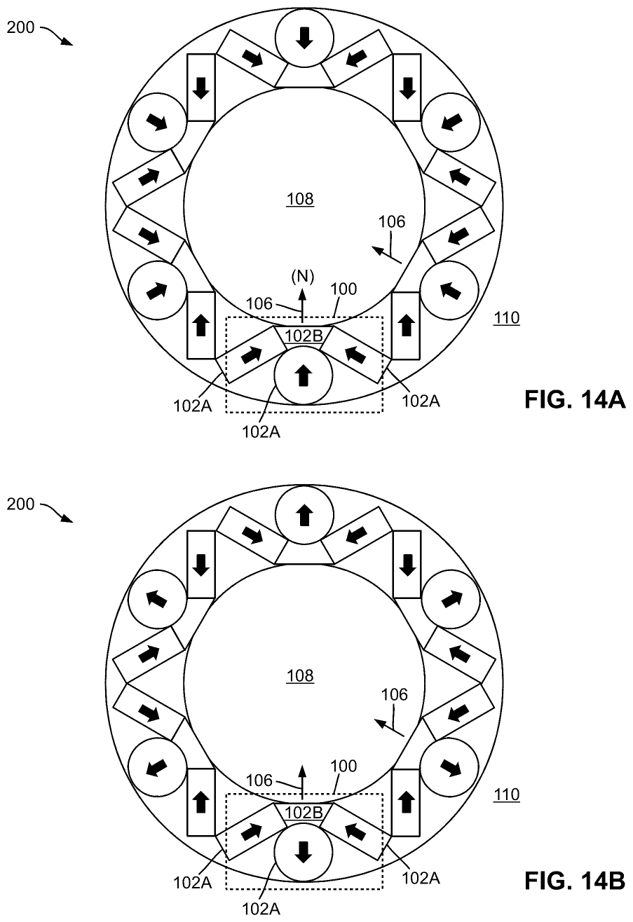

FIGS. 14A and 14B shows a magnetic apparatus 200 in some embodiments, wherein the front and rear layers 102 and 104 may be defined on respective curved surfaces and, for example, in the form of concentric cylinders or spheres. The target direction 106 comprises radially inward directions and the target side 108 is the interior side of the magnetic apparatus 200.

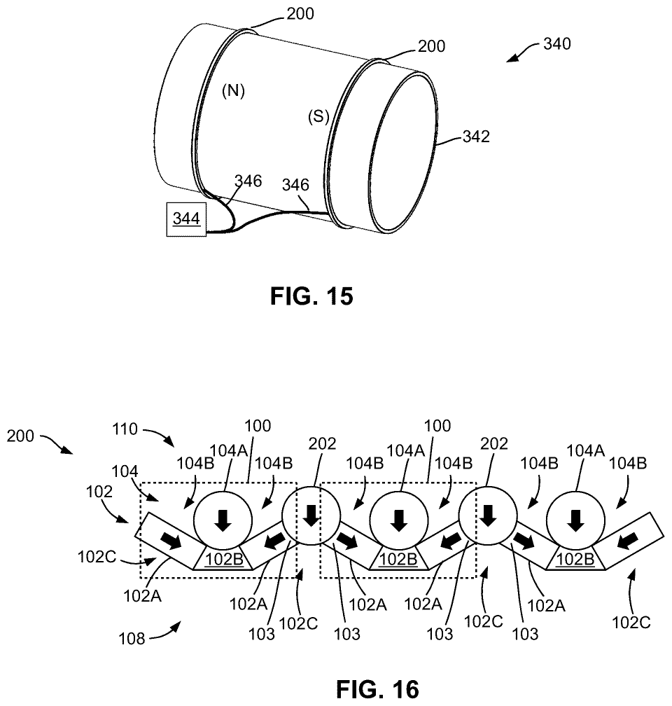

FIG. 15 shows a degausser 340 for demagnetizing a magnetic or magnetized work-piece 342. The degausser 340 comprises a pair of magnetic apparatuses 200 shown in FIGS. 14A and 14B, which may be switched ON and OFF using a motor 344 via a suitable mechanical mechanism 346. The magnetic apparatuses 200 are spaced apart and receive on their interior sides the work-piece 342 to be demagnetized. When are switched ON, the magnetic apparatuses 200 generate a plurality of circumferentially distributed N poles and a plurality of S poles at the respective positions for demagnetizing the work-piece 342. The magnetic-flux strength of the magnetic apparatuses 200 may be modulated accurately at a desired level between a maximum and a minimum for fully demagnetizing the work-piece 342.

With the example shown in FIG. 15, those skilled in the art will appreciate that the magnetic apparatus 100 or 200 described above may also be used in various degaussers for demagnetizing work-pieces.

In some embodiments, the magnetic apparatus 100 or 200 may be used in other devices such as electronic devices, sensors, and the like.

FIG. 16 shows a magnetic apparatus 200 in some embodiments. The magnetic apparatus 200 is similar to that shown in FIGS. 8A and 8B except that the magnetic apparatus 200 in these embodiments further comprises one or more secondary magnets 202 in the rear layer 104 thereof. Each secondary magnet 202 is located between the neighboring magnetic units 100 and overlaps the distal ends of the neighboring front-layer magnets 102A. The polarities of the secondary magnets 202 are the same as those of the rear-layer magnets 104A for reducing the impact of the distal poles 103 of the front-layer magnets 102A to the target side 108, and may be rotated in the same manner as those of the rear-layer magnets 104A.

Those skilled in the art will appreciate that, in various embodiments, the magnets described above such as the magnets 102A and 104A may each be a single component or the combination of a plurality of magnetic elements, and may have any suitable shapes. When a magnet 102A/104A is formed by a plurality of magnetic elements, the polarities of the plurality of magnetic elements are preferably aligned.

In some embodiments, the magnetic apparatuses 100 or 200 disclosed herein may not be switchable and may be always configured in the ON state.

The magnets described above (including the magnets 102A, 104A, and in some embodiments the magnets 202) are preferably permanent magnets. In some embodiments, at least some of these magnets may be electromagnetic components.

In some embodiments, the magnetic apparatus comprises at least one stationary magnet having a polarity along a longitudinal direction (that is, aiming towards or away from the work-piece), at least one rotatable magnet on a lateral side of the at least one stationary magnet and rotatable between an ON position and an OFF position, and a plurality of ferromagnetic components longitudinally sandwiching the at least one stationary magnet and the at least one rotatable magnet therebetween.

When the at least one rotatable magnet is at the ON position, a polarity thereof is aligned with the polarity of the at least one stationary magnet thereby forming a first pole on a longitudinally first side of the switchable magnetic device for generating magnetic flux therefrom along a longitudinally first target direction (in other words, enabling the magnetic field or magnetic flux along the longitudinally first target direction). The aligned polarities of the at least one stationary magnet and the at least one rotatable magnet may also form a second, opposite pole on a longitudinally second, opposite side of the switchable magnetic device along a longitudinally second target direction.

When the at least one rotatable magnet is at the OFF position, the polarity thereof is oriented opposite or reversed to the polarity of the at least one stationary magnet thereby cancelling the first and second poles and the magnetic flux generated therefrom (in other words, disabling the magnetic field or magnetic flux along the longitudinally first target direction).

The magnetic apparatus may be constructed to have either the S pole or the N pole on a target direction in the ON state. Moreover, in the embodiments wherein the magnetic apparatus has two opposite longitudinal target directions (wherein one has the S pole and the other has the N pole), the magnetic apparatus may be relatively symmetrical along the longitudinal direction such that a user may easily apply either the S pole or the N pole to a work-piece.

As described above, in the ON state, the polarities of the one or more rotatable magnets are aligned with those of the stationary magnets. Thus, the magnetic flux leaving the stationary and rotatable magnets along a target direction (through one or more ferromagnetic flux guides) has the same pole (either both S or both N), thereby forming a first pole for applying or enabling a large amount of same-pole flux with high flux density to a large area of a work-piece on the target direction.

In the OFF state, the polarities of the one or more rotatable magnets are opposite to those of the stationary magnets. Thus, the magnetic flux leaving the stationary and rotatable magnets along a target direction has opposite poles (either S/N or N/S). Consequently, the flux leaving each of these poles is attracted to the other pole and creates a magnetic “short-circuit” that keeps the flux largely or entirely internal to the magnetic apparatus, thereby cancelling or disabling the first pole and the magnetic flux.

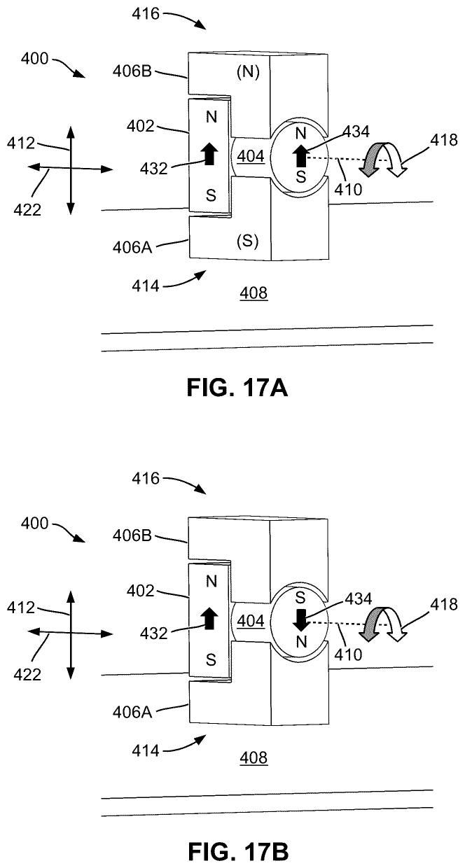

FIGS. 17A and 17B show a magnetic apparatus 400 according to some embodiments of this disclosure. The magnetic apparatus 400 is symmetric about a central axis 410 along a longitudinal direction 412 (which defines a first side 414 and a second side 416), and comprises a stationary magnet 402 and a rotatable magnet 404 arranged side by side along a lateral direction 422 and longitudinally sandwiched between a pair of stationary flux guides 406A and 406B made of suitable ferromagnetic materials such as iron, nickel, cobalt, and some alloys thereof.

Although not shown, the magnetic apparatus 400 also comprises a housing for receiving the magnets 402 and 404 and the flux guides 406A and 406B therein and constraining these components in place. The housing may have a thickness sufficient to contain any leaked magnetic flux internal thereto. With the magnetic flux contained, external ferromagnetic components will not be attracted to any side of the magnetic apparatus 400 at the OFF state and will not be attracted to any side except the target side or sides of the magnetic apparatus 400 at the ON state, thereby enhancing the safety of the magnetic apparatus 400.

The stationary magnet 402 has a polarity 432 arranged along the longitudinal direction 412 (which is the target direction herein). For illustrative purpose only, the polarity 432 is defined as the polarity from the S pole to the N pole.

The rotatable magnet 404 is rotatable about the central axis 410 as indicated by the arrow 418 for switching the magnetic apparatus 400 between an ON state and an OFF state. The rotation of the rotatable magnet 404 may be conducted using a suitable mechanism (not shown) coupled to the rotatable magnet 404 such as a manual lever or handle, an electric motor, a pneumatic actuator, or combustion engine, and/or the like.

In the ON state as shown in FIG. 17A, the rotatable magnet 404 is at a first orientation (denoted an “ON position”) such that the polarity 434 thereof is also arrange along the longitudinal direction 412 and aligned with that of the stationary magnet 402 such that the stationary and rotatable magnets 402 and 404 have the same pole facing the first side 414 (and also have the same, opposite pole facing the second side 416).

Consequently, the flux guides 406A and 406B are magnetized by the stationary and rotatable magnets 402 and 404 to form the poles same as those of the stationary and rotatable magnets 402 and 404 adjacent thereto for generating or enabling magnetic flux out of the magnetic apparatus 400 along longitudinally opposite sides 414 and 416 (which are two longitudinally opposite target sides). When a ferromagnetic work-piece 408 is positioned adjacent the first side 414 or the second side 416, the magnetic flux (not shown) between the magnetized poles of the flux guides 406A and 406B is then directed through the ferromagnetic work-piece 408. As a result, the ferromagnetic work-piece 408 is attracted to the magnetic apparatus 400.

For example, as shown in FIG. 17A, the flux guide 406A is magnetized by the stationary and rotatable magnets 402 and 404 to the S pole (denoted as “(S)” wherein “( )” represents a magnetized pole), and the flux guide 406B is magnetized by the stationary and rotatable magnets 402 and 404 to the N pole (denoted as “(N)”). When a ferromagnetic work-piece 408 is positioned adjacent the first side 414 or the second side 416, the magnetic flux (not shown) between the magnetized S and N poles of the flux guides 406A and 406B is then directed through the ferromagnetic work-piece 408, and the ferromagnetic work-piece 408 is attracted to the magnetic apparatus 400.

In the OFF state as shown in FIG. 17B, the rotatable magnet 404 is rotated about the central axis 410 to a second orientation (denoted an “OFF position”) such that the polarity 434 thereof is arrange along the longitudinal direction 412 and is in a reversed direction to that of the stationary magnet 402 such that the stationary and rotatable magnets 402 and 404 have opposite poles facing the first side 414 (and also have opposite poles facing the second side 416).

Consequently, a magnetic “short-circuit” is formed between the stationary and rotatable magnets 402 and 404 through the flux guides 406A and 406B. As the magnetic flux between the stationary and rotatable magnets 402 and 404 is mainly contained in the flux guides 406A and 406B, and a small amount of magnetic flux (or virtually no magnetic flux) is directed through the adjacent work-piece 408, the magnetic apparatus 400 thus generally disables the magnetic field or magnetic flux and exhibits small or virtually no attraction to the work-piece 408.

Also shown in FIGS. 17A and 17B, the magnets 402 and 404 are close to or in contact with the ferromagnetic guides 406A and 406B to reduce or eliminate the gaps therebetween for improving or maximizing the strength of the magnetic flux. For this purpose, the rotatable magnet 404 has curved surfaces at the two poles and the ferromagnetic guides 406A and 406B have corresponding curved surfaces adjacent the rotatable magnet 404. For example, in the embodiments shown in FIGS. 17A and 17B, the rotatable magnet 404 has a cylindrical shape (that is, a cylinder) and the ferromagnetic guides 406A and 406B have corresponding cylindrical surfaces adjacent the rotatable magnet 404. In some embodiments, the rotatable magnet 404 may have a ball shape.

A drawback of the magnetic apparatus 400 shown in FIGS. 17A and 17B is that, when the rotatable magnet 404 is at the OFF position (the magnetic apparatus 400 is in the OFF state), a strong rotational actuation force is generally required to break the magnetic short-circuit and overcome a resistive force towards the OFF position, to rotate the rotatable magnet 404 to the ON position. Furthermore, the rotatable magnet 404 is unstable at the ON position and may require a locking mechanism to maintain the rotatable magnet 404 at the ON position.

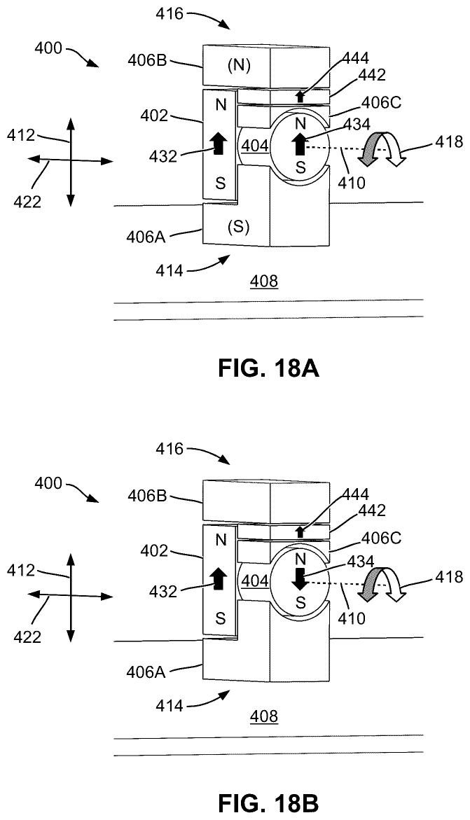

FIGS. 18A and 18B show a magnetic apparatus 400 with reduced switching resistance, according to some embodiments of this disclosure. The magnetic apparatus 400 in these embodiments allows reduced actuation force for switching the magnetic apparatus 400 from the OFF state to the ON state, and provides improved stability of the rotatable magnet 404 at the ON position.

The magnetic apparatus 400 in these embodiments is similar to that shown in FIGS. 17A and 17B except that the flux guide 406B in these embodiments has a cubical shape and the magnetic apparatus 400 further comprises a stationary flux guide 406C and an actuation-resistance-reduction magnet 442, sandwiched between the flux guide 406B and the rotatable magnet 404 with the actuation-resistance-reduction magnet 442 on the second side of the stationary flux guide 406C.

The stationary flux guide 406C is made of a suitable ferromagnetic material and has a curved surface adjacent the rotatable magnet 404 for adapting to the curved surface thereof and reducing/eliminating the gap therebetween.

The actuation-resistance-reduction magnet 442 is oriented such that the polarity 444 thereof is aligned with the polarity 434 of the rotatable magnet 404 when the rotatable magnet 404 is at the ON position, and is opposite to the polarity 434 of the rotatable magnet 404 when the rotatable magnet 404 is at the OFF position.

When the magnetic apparatus 400 is in the ON state, the adjacent ends of the rotatable magnet 404 and the actuation-resistance-reduction magnet 442 have opposite poles. Consequently, the actuation-resistance-reduction magnet 442 provides an attractive force to the rotatable magnet 404 and improves the stability thereof at the ON position. Moreover, the actuation-resistance-reduction magnet 442 further “pushes” the magnetic flux towards the first side 414 of the magnetic apparatus 400 thereby increasing the strength of the magnetic flux on the first side 414 of the magnetic apparatus 400.

When the magnetic apparatus 400 is in the OFF state, the adjacent ends of the rotatable magnet 404 and the actuation-resistance-reduction magnet 442 have the same pole. Consequently, the actuation-resistance-reduction magnet 442 provides a repelling force to the rotatable magnet 404 and reduces the resistive force when rotating the rotatable magnet 404 from the OFF position towards the ON position. The magnetic strength of the actuation-resistance-reduction magnet 442 may be chosen so that the resistive force against rotating the rotatable magnet 404 is minimized, or a desired user functionality is achieved.

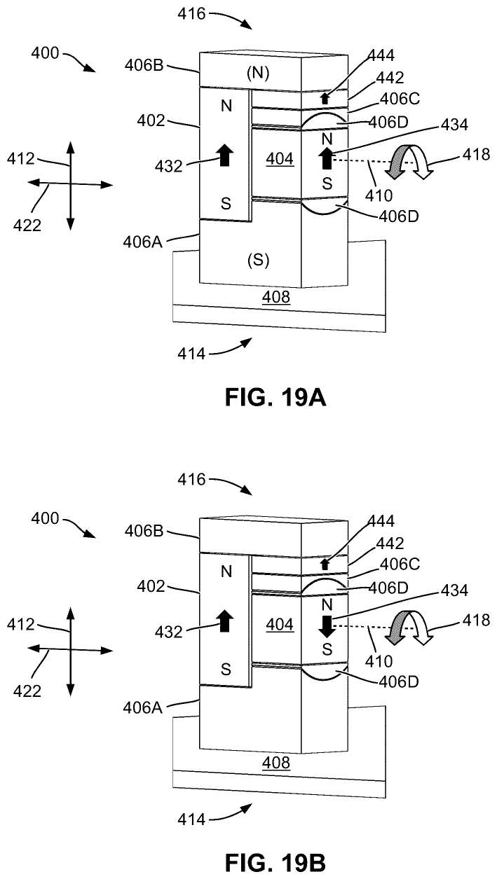

FIGS. 19A and 19B show a magnetic apparatus 400 in some embodiments. The magnetic apparatus 400 in these embodiments is similar to that shown in FIGS. 18A and 18B except that the rotatable magnet 404 in these embodiments is replaced with a rotatable magnetic structure having a rectangular rotatable magnet 404 and a pair of rotatable flux guides 406D made of a suitable ferromagnetic material. The pair of rotatable flux guides 406D are coupled to the poles of the rotatable magnet 404 and rotatable therewith. Each rotatable flux guide 406D has a curved surface (such as a cylindrical surface) adjacent the corresponding stationary flux guide 406C for reducing or eliminating the gap therebetween.

Those skilled in the art will appreciate that, in some embodiments, any one of the above-described ferromagnetic flux guides 406A to 406D may be a single ferromagnetic component or comprise a plurality of ferromagnetic components coupled together. Similarly, any one of the above-described magnets 402, 404, and 414 may be a single magnet or comprise a plurality of magnetic components with aligned polarities coupled together.

In various embodiments, the magnetic apparatus 400 disclosed herein may be used for various purposes such as for picking and releasing ferromagnetic work-pieces, collecting ferromagnetic particles and debris, and/or the like.

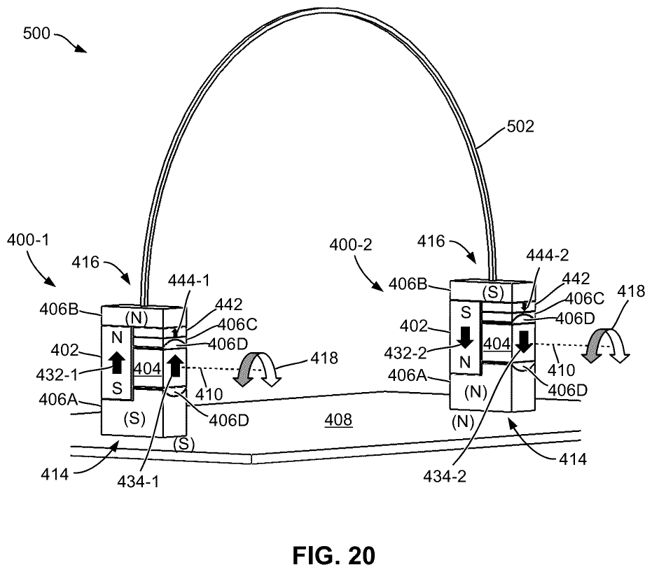

FIG. 20 shows a magnetic particle tester 500 in some embodiments which uses a nondestructive testing (NDT) technology to detect surface and slightly subsurface flaws in a ferromagnetic work-piece. As is known in the art, one may engage a magnetic particle tester with a ferromagnetic work-piece and spread ferromagnetic particles on the surface of the work-piece. The magnetic particle tester applies magnetic flux through the work-piece. Any cracks or defects in the work-piece will interrupt the magnetic flux and cause magnetic flux “leaking” out of the work-piece, which attracts the ferromagnetic particles thereto and thereby indicates the locations of defects.

As shown in FIG. 20, the magnetic particle tester 500 comprises a pair of magnetic apparatuses 400-1 and 400-2 spaced apart from each other and connected on the second sides 416 thereof by a connector 502. In some embodiments, the connector 502 may be a flexible cable.

Each of the magnetic apparatuses 400-1 and 400-2 may be any magnetic apparatuses disclosed herein. The pair of magnetic apparatuses 400-1 and 400-2 are configured such that the poles on their first sides 414 are opposite to each other. For example, the magnets 432-1, 434-1, and 444-1 of the magnetic apparatus 400-1 may be oriented such that, when the magnetic apparatuses 400-1 is switched to the ON state, the first side 414 thereof is magnetized to the S pole. The magnets 432-2, 434-2, and 444-2 of the magnetic apparatus 400-2 may be oriented such that, when the magnetic apparatuses 400-2 is switched to the ON state, the first side 414 thereof is magnetized to the N pole.

When the first sides 414 of the two magnetic apparatuses 400-1 and 400-2 engage a ferromagnetic work-piece 408 and the two magnetic apparatuses 400-1 and 400-2 are switched to their ON states, the two magnetic apparatuses 400-1 and 400-2 apply opposite poles to the ferromagnetic work-piece 408 and thus applies magnetic flux between the two poles through the work-piece 408 with improved flux strength.

In some embodiments, the connector 502 that connects the two poles on the second sides of the two magnetic apparatuses 400-1 and 400-2 may be made of a ferromagnetic material. For example, the connector 502 may be a ferromagnetic cable. Such a ferromagnetic connector 502 facilitates a magnetic closed-circuit which further increases the flux strength going through the work-piece 408. Compared to prior-art magnetic particle tester, the magnetic particle tester 500 disclosed herein may apply magnetic flux to a work-piece between two magnetic poles spaced at a larger distance thereby allowing nondestructive examination of larger-size work-pieces.

The magnetic particle tester 500 or a device similar thereto may also be used in other areas. For example, in some embodiments, the magnetic particle tester 500 or a device similar thereto may be used for demagnetization of a magnetized work-piece wherein the device may apply magnetic flux in a direction opposite to the direction that the work-piece is magnetized, thereby temporarily or permanently demagnetizing the work-piece.

In the embodiments described below, the magnetic apparatus may provide alternating flux induction such that, when the magnetic apparatus engages a work-piece, the frequency of the alternating flux (denoted “alternating-flux frequency” or “switching frequency” hereinafter) may be controlled to control the depth and strength of the magnetic flux or field of the magnetic apparatus concentrated in the work-piece.

In some embodiments, the target side of the magnetic apparatus may have an alternating pole alternating between the N pole and the S pole thereby giving rise to alternating pole induction. In some embodiments, the target side of the magnetic apparatus may have an ON/OFF pole (that is, having the N pole or the S pole in an ON state and having no pole in an OFF state), thereby giving rise to alternating ON/OFF induction.

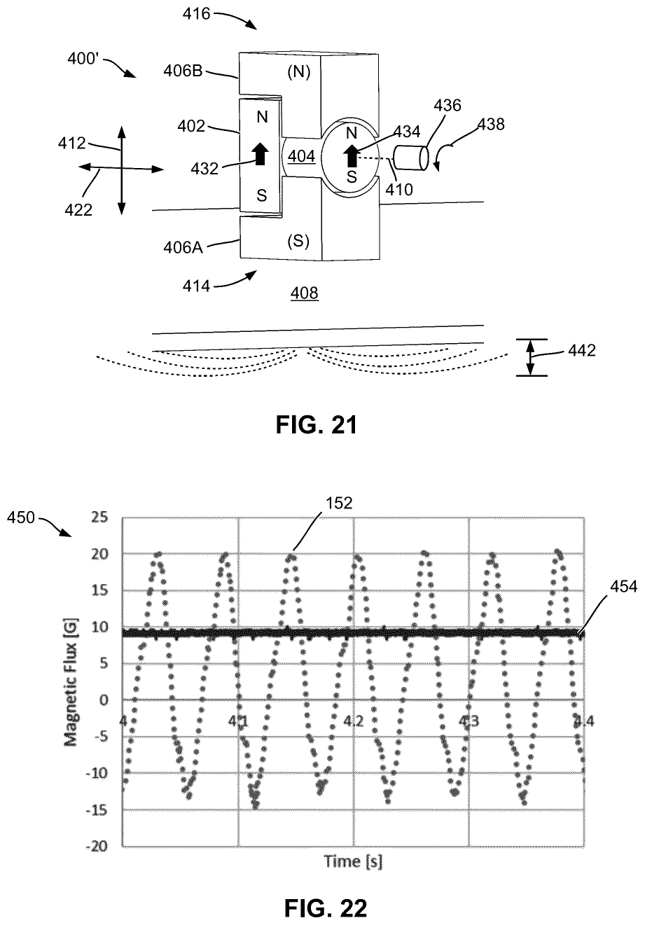

FIG. 21 shows an alternating flux induction magnetic apparatus 400′ according to some embodiments of this disclosure. The magnetic apparatus 400′ shown in FIG. 21 is similar to the magnetic apparatus 400 shown in FIG. 17A except that in these embodiments, the magnetic apparatus 400′ further comprises a driving component 436 such as a motor for driving the rotatable magnet 404 to rotate (indicated by the arrow 438) at a specific rotation speed such that the magnetic apparatus 400′ is switching between an ON state and an OFF state at a specific switching frequency for providing magnetic flux (or a magnetic field) to the ferromagnetic work-piece 408 with a reduced depth of the magnetic flux or field concentrated in the work-piece 408. Such a reduced depth 442 of the magnetic flux or field concentrated in the work-piece 408 may similar to the so-called “skin effect”. However, the skin effect in prior art is generally a drawback to avoid, while reducing the depth 442 of the magnetic flux concentrated in the work-piece 408 as disclosed herein may lead to increased magnetic-flux strength on or about the surface of the ferromagnetic work-piece 408 which may be advantageous in many applications such as NDT.

For example, FIG. 22 is a plot 450 showing the magnetic-flux strength 452 in Guass (G) of an alternating flux induction magnetic apparatus 400′ with the rotatable magnet 404 rotating at a speed of 15 revolutions per second (and therefore a 15 Hz ON-OFF switching), and the magnetic-flux strength 454 of the alternating flux induction magnetic apparatus 400′ with the rotatable magnet 404 maintained stationary in the ON position. Both magnetic-flux strengths 452 and 454 are measured at the surface of the work-piece 408. In FIG. 22, the positive and negative signs of the values represent the opposite poles of the magnetic flux. As can be seen, by switching the magnetic flux ON and OFF, the magnetic-flux strength 454 measured at the surface of the work-piece 408 is significantly increased.

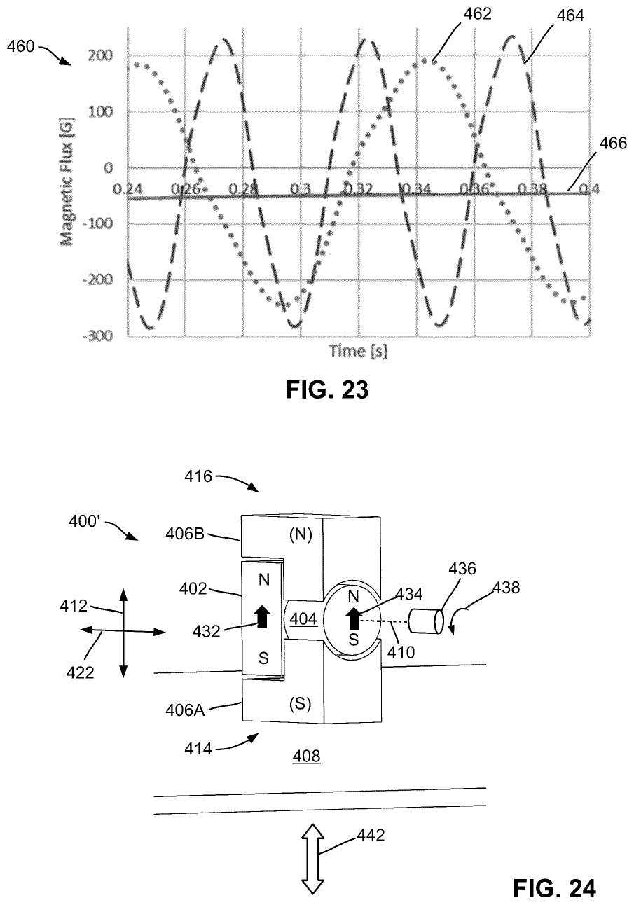

FIG. 23 is a plot 460 showing the test results of another alternating flux induction magnetic apparatus 400′, wherein the curve 462 represents the magnetic-flux strength when the alternating flux induction magnetic apparatus 400′ is switched ON and OFF at a switching frequency of 10 Hz, the curve 464 represents the magnetic-flux strength when the alternating flux induction magnetic apparatus 400′ is switched ON and OFF at a switching frequency of 20 Hz, and the curve 466 represents the magnetic-flux strength when the alternating flux induction magnetic apparatus 400′ is maintained stationary in the ON position. As can be seen, by switching the magnetic flux ON and OFF, the alternating flux induction magnetic-flux strength 454 measured at the surface of the work-piece 408 is significantly increased. Moreover, a higher switching frequency leads to a further increased magnetic-flux strength 454 measured at the surface of the work-piece 408.

As those skilled in the art will appreciate, the alternating flux induction may be related to the quick changing of the magnetic flux such that the magnetic flux is concentrated into the lowest resistance path in the work-piece 408. Different switching frequencies or speeds may lead to different depths 442 of the magnetic flux in the work-piece 408. Therefore, as shown in FIG. 24, in some embodiments, the driving component 436 may drive the rotatable magnet 404 to rotate at various rotation speeds to switch the alternating flux induction magnetic apparatus 400′ ON and OFF at different frequencies for adjusting the depths 442 of the magnetic flux in the work-piece 408 (for example, to detect defects in the work-piece 408 at different depths). In some embodiments, the driving component 436 may continuously adjust the ON-OFF switching frequency of the alternating flux induction magnetic apparatus 400′ between a switching-frequency range or may adjust the ON-OFF switching frequency thereof to a plurality of switching frequencies to implement a three-dimensional (3D) scan of the work-piece 408.

Those skilled in the art will appreciate that the driving component 436 may rotate the rotatable magnet 404 to and maintain it at the OFF position to disengage the alternating flux induction magnetic apparatus 400′ and the work-piece 408.

In some embodiments, the alternating flux induction magnetic apparatus 400′ may be similar to the magnetic apparatus 400 shown in FIG. 18A or 19A and further comprise a driving component 436 for rotating the rotatable magnet 404 to switch the magnetic apparatus ON and OFF at a switching frequency for providing alternating magnetic flux to the work-piece 408 (similar to the skin effect).

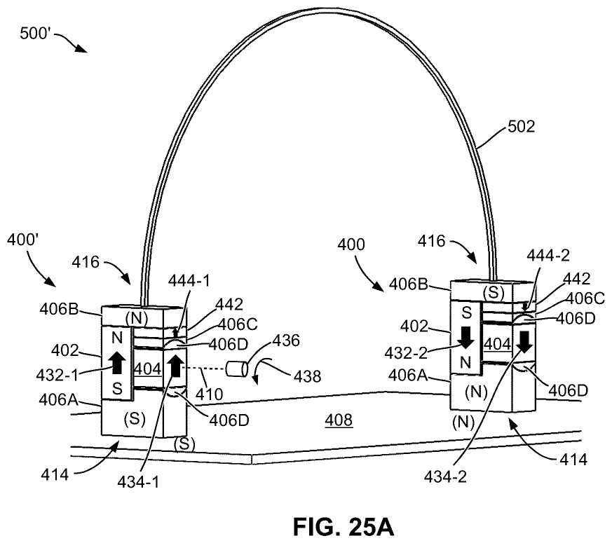

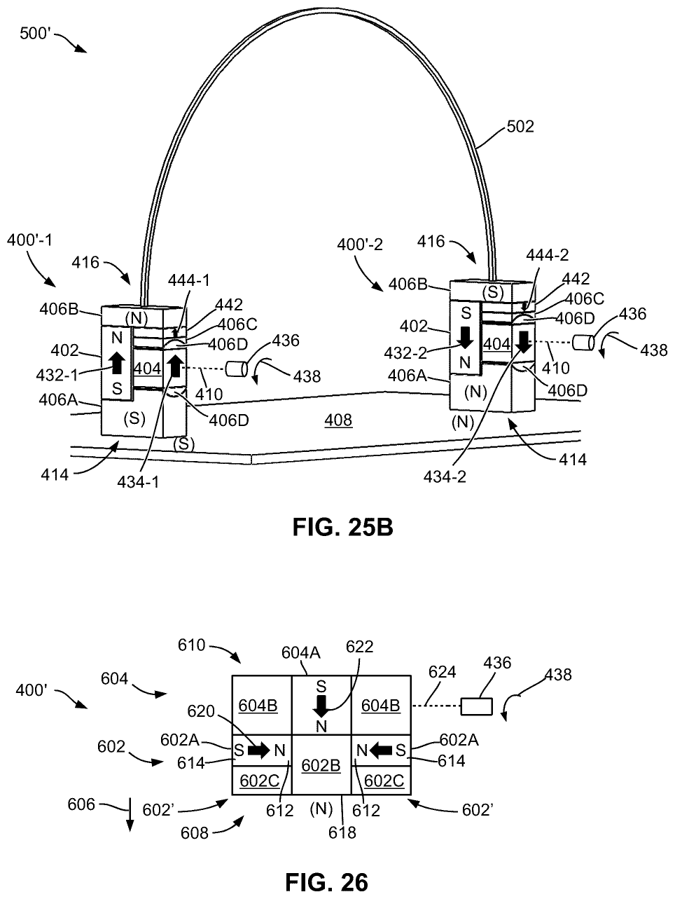

FIG. 25A shows a magnetic particle tester 500′ for detect surface and slightly subsurface flaws in a ferromagnetic work-piece 408 using the NDT technology, according to some embodiments of this disclosure. As shown, the magnetic particle tester 500′ is similar to the magnetic particle tester 500 shown in FIG. 20 except that the magnetic particle tester 500′ in these embodiments comprises a magnetic apparatus 400 and an alternating flux induction magnetic apparatus 400′. The alternating flux induction magnetic apparatus 400′ is switched ON and OFF at different switching frequencies for scanning the work-piece 408 and detecting defects at different depths.

In some embodiments as shown in FIG. 15B, the magnetic particle tester 500′ may comprise two spaced-apart alternating flux induction magnetic apparatuses 400′-1 and 400′-2 for generating opposite poles on the work-piece 408. The driving components 436 of the two alternating flux induction magnetic apparatuses 400′-1 and 400′-2 are configured to rotate the rotatable magnets 404 thereof.

In some embodiments, the alternating flux induction magnetic apparatus 400′ may be similar to the single-pole magnetic apparatus described above.

For example, FIG. 26 is schematic side view of a single-pole, alternating flux induction magnetic apparatus 400′ similar to the single-pole magnetic apparatus described in U.S. 63/555,891. As shown, the alternating flux induction magnetic apparatus 400′ comprises a front layer 602 and a rear layer 604 on the rear side 610 of the front layer 602 and in contact or in close proximity therewith. The front and rear layers 602 and 604 comprise a plurality of magnets and may further comprise one or more ferromagnetic flux guides. As those skilled in the art will appreciate, the magnets disclosed herein may be made of any suitable magnetic materials. For example, in some embodiments, the magnets disclosed herein may be N52-grade magnets with rectangular cross-sections. In some other embodiments, the magnets disclosed herein may comprise other permanent magnet materials such as NdFeB, NiCo, and/or the like. In some other embodiments, the magnets disclosed herein may be electromagnets. The one or more ferromagnetic flux guides may be made of any suitable ferromagnetic material such as steel.

The front layer 602 comprises a pair of front-layer magnet assemblies 602′ sandwiching therebetween a ferromagnetic flux guide 602B (also denoted a “ferromagnetic block” without referring specific shapes thereof).

Each front-layer magnet assembly 602′ comprises a front-layer magnet 602A and a non-ferromagnetic block 602C on the front side 608 of the front-layer magnet 602A. As those skilled in the art will appreciate, the non-ferromagnetic blocks disclosed herein, such as the non-ferromagnetic blocks 602C and the non-ferromagnetic blocks 604B (described in more detail later), may be made of any suitable non-ferromagnetic materials such as aluminum, plastic, or simply empty space (for example, air gaps or vacuum).

The front-layer magnets 602A of the front-layer magnet assemblies 602′ are in an end-to-end arrangement such that for the pair of the front-layer magnets 602A, a pair of the ends or poles 612 (denoted proximal ends or poles) are adjacent to each other and are at a distance smaller than that of the other pair of the ends or poles 614 thereof (denoted distal ends or poles). More specifically, the angle between the polarities of the front-layer magnets 602A with respect to the ferromagnetic block 602B therebetween is greater than 0° and smaller than 90°.

In these embodiments, each front-layer magnet 602A has a uniform thickness from the proximal pole 612 to the distal pole 614 which is smaller than that of the ferromagnetic block 602B. Therefore, the distal pole 614 thereof is on the rear side of the front edge 618 of the alternating flux induction magnetic apparatus 400′ (or more specifically the front edge of the ferromagnetic block 602B) and at a distance thereto. Moreover, the front-layer magnets 602A are oriented with reversed polarities or magnetization vectors 620 such that the ferromagnetic block 602B is adjacent to the same poles (being either the N pole or the S pole) of the front-layer magnets 602A in both an ON state and an OFF state.

The rear layer 604 comprises a rear-layer magnet 604A sandwiched between two non-ferromagnetic blocks 604B. The rear-layer magnet 604A overlaps the ferromagnetic block 602B along the target direction 606 and has a polarity or magnetization vector 622 aligned with the target direction 606. The non-ferromagnetic blocks 604B overlap respective front-layer magnets 602A along the target direction 606.

In these embodiments, the alternating flux induction magnetic apparatus 400′ further comprises a driving component 436 such as a motor for rotating the rear layer 604 or the rear-layer magnet 604A thereof (indicated by the arrow 438) about an axis 624 perpendicular to the polarity 622 thereof for switching the alternating flux induction magnetic apparatus 400′ ON and OFF at a switching frequency for providing an increased magnetic flux along the target direction 606 to a work-piece (not shown) on the target side 608.

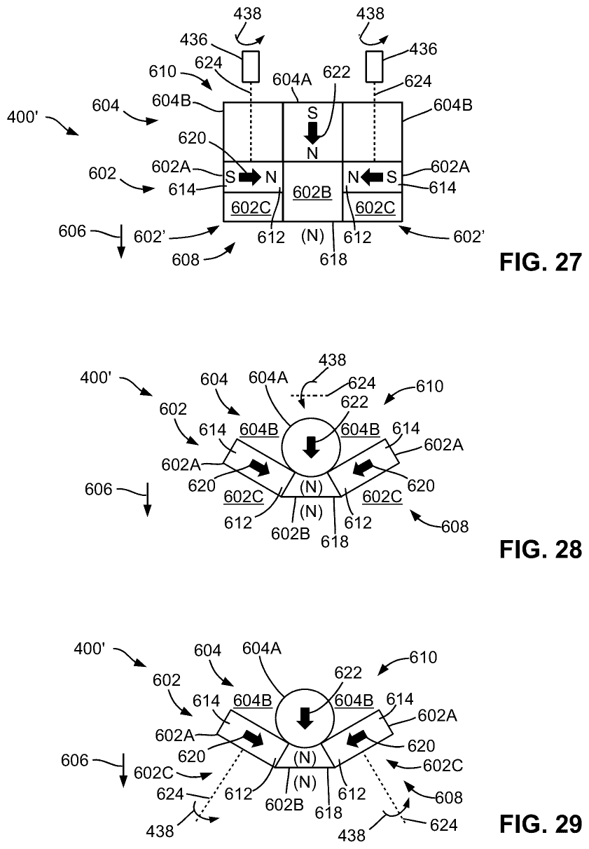

In some embodiments as shown in FIG. 27, instead of rotating the rear-layer magnet 604A, the alternating flux induction magnetic apparatus 400′ may comprise a pair of driving components 436 for synchronously rotating the front-layer magnets 602A about respective axes 624 for switching the alternating flux induction magnetic apparatus 400′ ON and OFF at a switching frequency for providing increased magnetic flux along the target direction 606 to a work-piece (not shown) on the target side 608.

FIG. 28 shows the alternating flux induction magnetic apparatus 400′ in some embodiments. The alternating flux induction magnetic apparatus 400′ in these embodiments is similar to that shown in FIG. 26 except that, in these embodiments, the proximal pole 612 of each front-layer magnet 602A is adjacent the front edge 618 of the alternating flux induction magnetic apparatus 400′ and fully engages the ferromagnetic block 602B, thereby allowing the alternating flux induction magnetic apparatus 400′ in these embodiments to generate further-enhanced single-pole magnetic flux on the target side 608 compared to that shown in FIG. 26. The alternating flux induction magnetic apparatus 400′ comprises a driving component (not shown) for rotating the rear-layer magnet 604A (indicated by the arrow 438) about an axis 624 crossing the center of the rear-layer magnet 604A and perpendicular to the polarity 622 thereof at a switching frequency for providing increased magnetic flux along the target direction 606 to a work-piece (not shown) on the target side 608, although for ease of illustration, the axis 624 in FIG. 28 (and similarly in other figures) are not shown as crossing the center of the rear-layer magnet 604A.

In some embodiments as shown in FIG. 29, the alternating flux induction magnetic apparatus 400′ may comprise a pair of driving components (not shown) for synchronously rotating the front-layer magnets 602A about respective axes 624 perpendicular to the respective magnetization vectors 620 for switching the alternating flux induction magnetic apparatus 400′ ON and OFF at a switching frequency for providing an increased magnetic flux along the target direction 606 to a work-piece (not shown) on the target side 608.

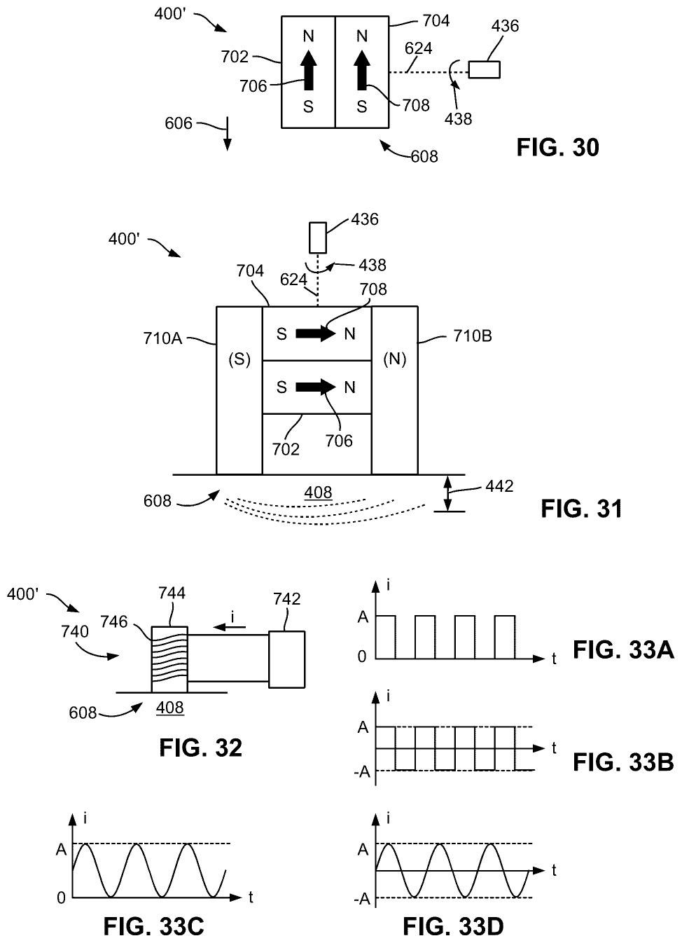

In some embodiments as shown in FIG. 30, the alternating flux induction magnetic apparatus 400′ may comprise a stationary magnet 702 and a rotatable magnet 704 arranged side-by-side with the polarities or magnetization vectors 706 and 708 thereof in parallel when the alternating flux induction magnetic apparatus 400′ is in the ON state. The alternating flux induction magnetic apparatus 400′ also comprises a driving component 436 such as a motor for rotating the rotatable magnet 704 (indicated by the arrow 438) about an axis 624 perpendicular to the polarity 708 thereof for switching the alternating flux induction magnetic apparatus 400′ ON and OFF at a switching frequency for providing an increased magnetic flux along the target direction 606 to a work-piece (not shown) on the target side 608.

FIG. 31 shows the alternating flux induction magnetic apparatus 400′ in some embodiments. Similar to that shown in FIG. 30, the alternating flux induction magnetic apparatus 400′ in these embodiments comprises stationary magnet 702 and a rotatable magnet 704 arranged side-by-side with the polarities or magnetization vectors 706 and 708 thereof in parallel when the alternating flux induction magnetic apparatus 400′ is in the ON state. The alternating flux induction magnetic apparatus 400′ also comprises a pair of stationary flux guides 710A and 710B made of suitable ferromagnetic materials and coupled to the two polarity ends (that is, the two poles) of the stationary magnet 702. Thus, when the pair of stationary flux guides 710A and 710B engage a work-piece 408 on the target side 608 thereof and the alternating flux induction magnetic apparatus 400′ is in the ON state, the pair of stationary flux guides 710A and 710B engage the N polarity ends and S polarity ends of both magnets 702 and 704 and direct the magnetic flux to traverse the work-piece 408 between the pair of stationary flux guides 710A and 710B.

In these embodiments, the alternating flux induction magnetic apparatus 400′ further comprises a driving component 436 such as a motor for rotating the rotatable magnet 704 (indicated by the arrow 438) about an axis 624 perpendicular to the polarity 708 thereof for switching the alternating flux induction magnetic apparatus 400′ ON and OFF at a switching frequency for providing an increased magnetic flux to the work-piece 408 on the target side 608 with a reduced depth 442 of the magnetic flux concentration in the work-piece 408.

Those skilled in the art will appreciate that the magnets used in above embodiments may be any suitable permanent magnets.

Those skilled in the art will appreciate that in various embodiments, any magnetic apparatus may be used as a switchable magnetic component of the alternating flux induction magnetic apparatus wherein the switchable magnetic component may engage one or more driving components for switching the switchable magnetic component ON and OFF to enable and disable magnetic flux at a switching frequency for providing increased magnetic flux to a work-piece and/or for providing 3D scanning for the work-piece.

With above embodiments and examples, those skilled in the art will understand that the reduced depth of the magnetic flux concentration in the work-piece 408 (in other words, the increased magnetic flux concentration in the work-piece 408) may be achieved by applying and removing a magnetic pole or by alternatingly applying opposite magnetic poles to the work-piece 408 repeatedly at a switching frequency. The depth reduction of the magnetic flux concentration in the work-piece 408 or the increase of the magnetic flux concentration in the work-piece 408 may be controlled by controlling or adjusting the switching frequency.

In some embodiments as shown in FIG. 32, the alternating flux induction magnetic apparatus 400′ may comprise an electromagnetic component 740 functionally coupled to a control circuit 742 (which may be considered an electrical driving component). For example, the electromagnetic component 740 may comprise a ferromagnetic core 744 with electrically conductive coils 746 winding thereabout. The control circuit 742 is connected to the electrically conductive coils 746 and controls or otherwise electromagnetically drives the electromagnetic component 740 to vary the magnetic pole applied to a work-piece 408 on the front side 608 of the electromagnetic component 740 by applying an alternating current i to the coils 746. FIGS. 33A to 33D show some example of the alternating current applied to the coils 746, wherein FIG. 33A shows an ON/OFF current i having a square waveform with the amplitude thereof switching between A and zero (0), FIG. 33B shows an alternating-direction current i having a square waveform with the amplitude thereof switching between A and −A, FIG. 33C shows the current i in the form of a sine waveform with the amplitude thereof switching between A and zero (0), and FIG. 33D shows the current i in the form of a sine waveform with the amplitude thereof switching between A and −A.

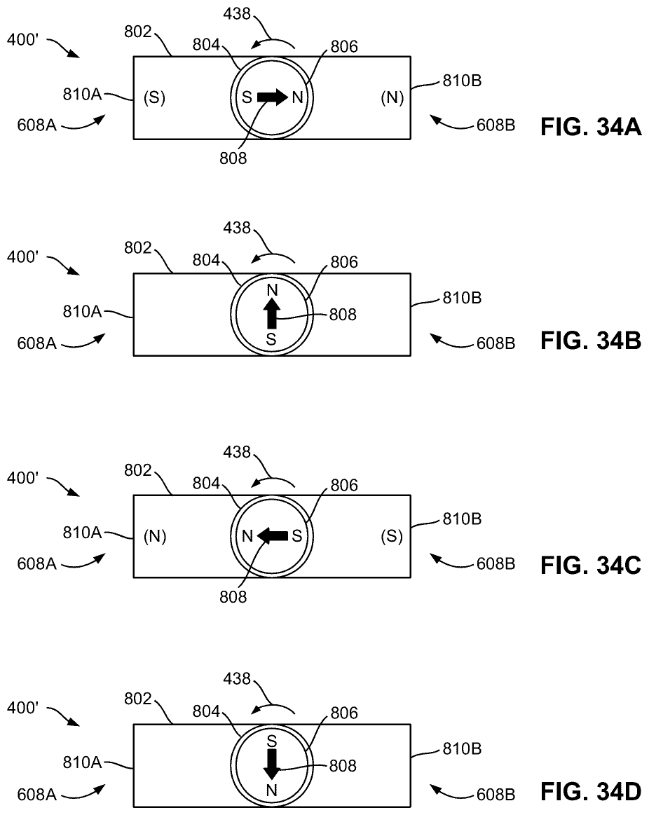

FIGS. 34A to 34D are schematic plan views of a magnetic apparatus 400′ according to some embodiments of this disclosure, wherein the magnetic apparatus 400′ shown in FIGS. 34A and 34C is in the ON state and that shown in FIGS. 34B and 34D is in the OFF state.

The magnetic apparatus 400′ in these embodiments comprises a ferromagnetic piece 802 having a recess 804 rotatably receiving therein a magnetic component 806. A rotation driver (such as a motor or a servo; not shown) is connected to the rotatable magnetic component 806 for rotating it (as indicated by the arrow 438) at a specific rotation speed.

The magnetic apparatus 400′ has opposite target sides 608A and 608B along a longitudinal direction. As shown, in FIG. 34A when the magnetic component 806 is rotated to an ON position wherein the polarity 808 of the magnetic component 806 is perpendicular to the target sides 608A and 608B, the two opposite ends 810A and 810B of the ferromagnetic piece 802 on the target sides 608A and 608B are magnetized to opposite poles(S) and (N). When the magnetic component 806 is rotated to an OFF position as shown in FIG. 34B, wherein the polarity 808 of the magnetic component 806 is parallel to the target sides 608A and 608B, the two opposite ends 810A and 810B of the ferromagnetic piece 802 on the target sides 608A and 608B have no poles (that is, the two magnetized poles are cancelled).

The magnetic component 806 may be further rotated to another ON position shown in FIG. 34C, wherein the two opposite ends 810A and 810B of the ferromagnetic piece 802 on the target sides 608A are magnetized to opposite poles (N) and(S). As shown in FIG. 34D, the magnetic component 806 may be further rotated to another OFF position and the two magnetized poles at the two opposite ends 810A and 810B of the ferromagnetic piece 802 are cancelled. Further rotation of the magnetic component 806 will return to the first ON position shown in FIG. 34A.

Thus, the rotation driver may control the rotatable magnetic component 806 to rotate it at a specific rotation speed to alternatingly apply opposite poles to the two ends 810A and 810B of the ferromagnetic piece 802 at a corresponding switching frequency.

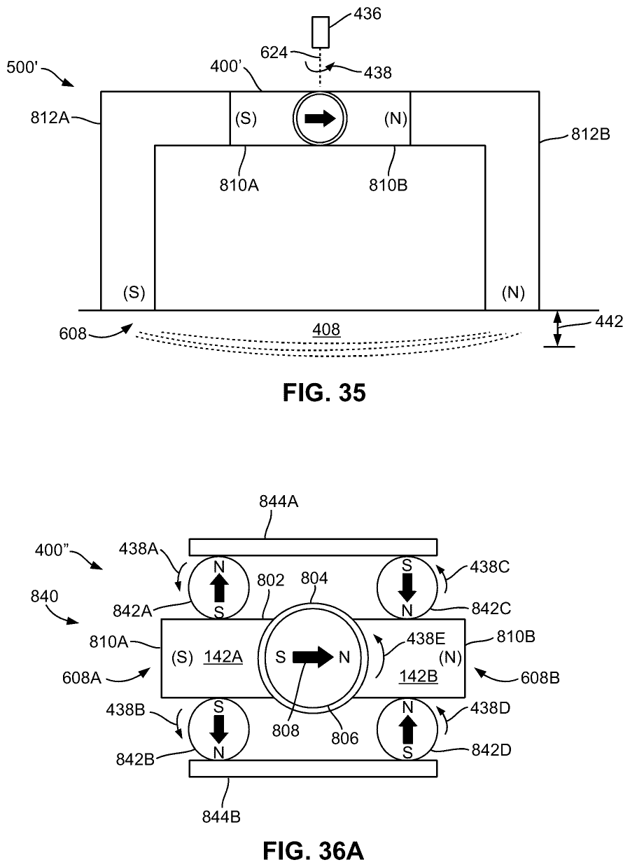

FIG. 35 shows a magnetic particle tester 500′ for detect surface and slightly subsurface flaws in a ferromagnetic work-piece 408 using the NDT technology, according to some embodiments of this disclosure. As shown, the magnetic particle tester 500′ in these embodiments comprises a magnetic apparatus 400′ shown in FIG. 34A with the two opposite ends 810A and 810B thereof coupled to two legs 812A and 812B for engaging a work-piece 408 at the front side 608 thereof. The rotation driver 436 controls the rotatable magnetic component 806 of the magnetic apparatus 400′ to rotate it at a specific rotation speed to alternatingly apply opposite poles to the two legs 812A and 812B at a corresponding switching frequency for providing an increased magnetic flux to the work-piece 408 on the target side 608 with a reduced depth 442 of the magnetic flux concentration in the work-piece 408.

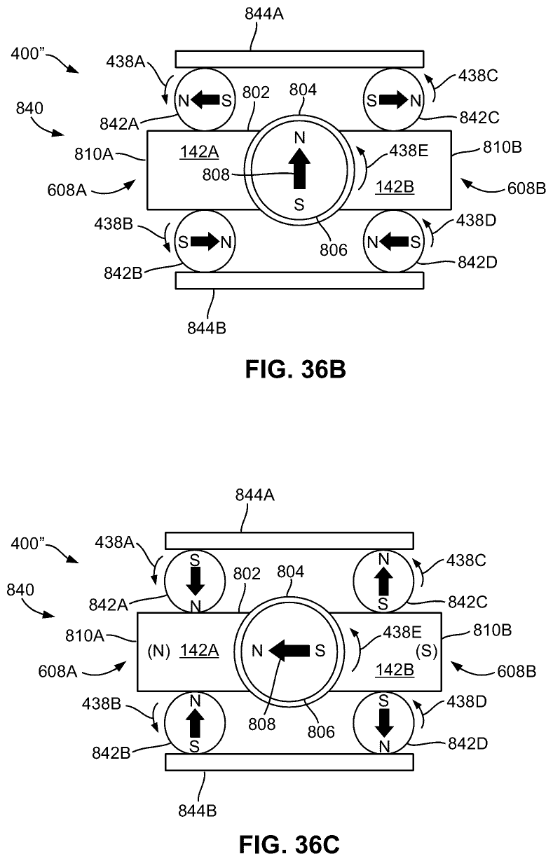

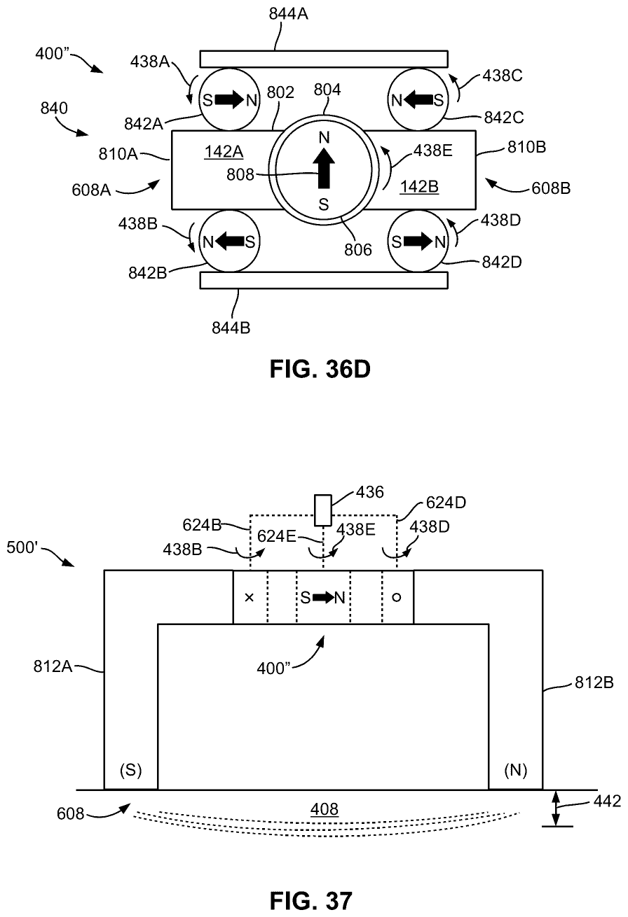

FIGS. 36A to 36D are schematic plan views of a magnetic apparatus 400″ according to some embodiments of this disclosure, wherein the magnetic apparatus 400″ shown in FIGS. 36A and 36C is in the ON state and that shown in FIGS. 36B and 36D is in the OFF state.

The magnetic apparatus 400″ in these embodiments comprises a central structure 840 similar to the magnetic apparatus 400′ shown in FIG. 34A. More specifically, the central structure 840 comprises a ferromagnetic piece 802 having a recess 804 rotatably receiving therein a magnetic component 806. A rotation driver (such as a motor or a servo; not shown) is connected to the rotatable magnetic component 806 for rotating it at a specific rotation speed.

The central structure 840 has opposite target sides 608A and 608B (which are also the target sides of the magnetic apparatus 400″) along a longitudinal direction. A pair of magnetic components 842A and 842B are positioned on the opposite lateral sides of the ferromagnetic piece 802 intermediate the magnetic component 806 and the end 810A of the ferromagnetic piece 802 and rotatably engaging the ferromagnetic piece 802 or at a small distance thereto. Similarly, a pair of magnetic components 842C and 842D are positioned on the opposite lateral sides of the ferromagnetic piece 802 intermediate the magnetic component 806 and the end 810B of the ferromagnetic piece 802 and rotatably engaging the ferromagnetic piece 802 or at a small distance thereto.

The rotatable magnetic components 842A, 842B, 842C, 842D, and 806 may be synchronously rotated as indicated by the arrows 438A, 438B, 438C, 438D, ad 438E) at a specific rotation speed (for example, synchronously driven by respective rotation drivers or by a single rotation driver via a gear system). When the magnetic components 842A, 842B, 842C, 842D, and 806 are rotated to their ON positions, the poles of the respective magnetic components in the target area adjacent each target side are the same poles. For example, in the ON state shown in FIG. 36A, the adjacent poles of the magnetic components 804, 842A, and 842B in the target area 142A adjacent the target side 608A are the S pole and the end 810A of the ferromagnetic piece 802 is magnetized to the(S) pole; and the adjacent poles of the magnetic components 804, 842C, and 842D adjacent the target side 608B are the N pole and the end 810B of the ferromagnetic piece 802 is magnetized to the (N) pole. In the ON state shown in FIG. 36C, the adjacent poles of the magnetic components 804, 842A, and 842B adjacent the target side 608A are the N pole and the end 810A of the ferromagnetic piece 802 is magnetized to the (N) pole; and the adjacent poles of the magnetic components 804, 842C, and 842D adjacent the target side 608B are the S pole and the end 810B of the ferromagnetic piece 802 is magnetized to the(S) pole.

When the magnetic components 842A, 842B, 842C, 842D, and 806 are rotated to their OFF positions, no poles of the respective magnetic components are in the target area adjacent each target side. The magnetized poles at the two ends 810A and 810B of the ferromagnetic piece 802 are then cancelled.

FIG. 37 shows a magnetic particle tester 500′ for detect surface and slightly subsurface flaws in a ferromagnetic work-piece 408 using the NDT technology, according to some embodiments of this disclosure. The magnetic particle tester 500′ in these embodiments is similar to that shown in FIG. 35 except that the magnetic particle tester 500′ in these embodiments comprises a magnetic apparatus 400″ shown in FIG. 36A. A rotation driver 436 synchronously drives the rotatable magnetic components 842A, 842B, 842C, 842D, and 806 via a gear system (not shown) to rotate them about respective axes 624A, 624B, 624C, 624D, and 624E (FIG. 37 only shows the axes 624B, 624D, and 624E) for providing an increased magnetic flux to the work-piece 408 on the target side 608 with a reduced depth 442 of the magnetic flux concentration in the work-piece 408.

Although embodiments have been described above with reference to the accompanying drawings, those of skill in the art will appreciate that variations and modifications may be made without departing from the scope thereof as defined by the appended claims.

What is claimed is:

1. A magnetic unit for generating a directional magnetic field towards a target direction on a front side thereof, the magnetic unit comprising:
a pair of front magnetic structures; and
a rear magnetic structure on a rear side of the front magnetic structures;
wherein each of the front magnetic structures and the rear magnetic structure comprises a first pole in a target area about a front edge of a target side;
wherein, in a first state, the first poles of the front magnetic structures and the rear magnetic structure are a same pole thereby forming a target pole in the target area for engaging a work-piece about the front edge; and
wherein each of the front magnetic structures and the rear magnetic structure comprises a second pole opposite to the respective first pole, the second poles of the front magnetic structures and the rear magnetic structure are on a rear side of the front edge and at a distance thereto.

2. The magnetic unit of claim 1, wherein the rear magnetic structure has a polarity aligned with the target direction; and
wherein each of the front magnetic structures has a polarity at an angle to the polarity of the rear magnetic structure.

3. The magnetic unit of claim 1, wherein each of the front magnetic structures has a polarity at an angle α to a polarity of the rear magnetic structure; and
wherein 0°<α<180°, 30°<α<180°, 60°<α<180°, 0°<α<90°, 30°<α<90°, 60°<α<90°, or α=90°.

4. The magnetic unit of any one of claims 1 to 3, wherein the first pole of the rear magnetic structure extends to the front edge.

5. The magnetic unit of claim 4, wherein the first poles of the front magnetic structures are spaced from the front edge.

6. The magnetic unit of any one of claims 1 to 4, wherein the first poles of the front magnetic structures extend to the front edge.

7. The magnetic unit of any one of claims 1 to 6, wherein the target area comprises one or more ferromagnetic pieces magnetically engaging the first poles of the front magnetic structures and the rear magnetic structure.

8. The magnetic unit of any one of claims 1 to 7, wherein the target side is beside a plane defined by the front magnetic structures; wherein the target side is a radially outer side of the magnetic unit; or wherein the target side is a radially inner side of the magnetic unit.

9. The magnetic unit of any one of claims 1 to 8, wherein in a second state, the first pole of the rear magnetic structure is different to the first poles of the front magnetic structures thereby cancelling the target pole in the target area.

10. The magnetic unit of claim 9, wherein at least one of the rear magnetic structure and the front magnetic structures are rotatable for rotating the polarities thereof to switch the magnetic unit between the first and second states.

11. The magnetic unit of claim 9 or 10 further comprising:
an actuation structure for rotating the polarities thereof to switch the magnetic unit between the first and second states.

12. A switchable magnetic unit having opposite first and second sides along a longitudinal direction, the switchable magnetic apparatus comprising:
at least one stationary magnet having a polarity along the longitudinal direction; and
at least one rotatable magnetic structure on a lateral side of the at least one stationary magnet and rotatable between an ON position and an OFF position, the at least one rotatable magnetic structure comprising at least one rotatable magnet;
wherein, when the at least one rotatable magnetic structure is at the ON position, a polarity thereof is aligned with the polarity of the at least one stationary magnet thereby forming a first pole on the first side of the switchable magnetic apparatus for generating magnetic flux therefrom; and
wherein, when the at least one rotatable magnetic structure is at the OFF position, the polarity thereof is opposite to the polarity of the at least one stationary magnet thereby cancelling the first pole and the magnetic flux generated therefrom.

13. The switchable magnetic unit of claim 12 further comprising:
a plurality of ferromagnetic flux guides longitudinally sandwiching the at least one stationary magnet and the at least one rotatable magnetic structure therebetween.

14. The switchable magnetic unit of claim 12 or 13 further comprising:
at least one actuation-resistance-reduction magnet on the second side of the at least one rotatable magnet for reducing the resistance during rotation of the at least one rotatable magnet.

15. The switchable magnetic unit of any one of claims 12 to 14 further comprising:
a first ferromagnetic component sandwiched between the at least one actuation-resistance-reduction magnet and the at least one rotatable magnet.

16. The switchable magnetic unit of any one of claims 12 to 15, wherein the rotatable magnetic structure further comprises:
a pair of rotatable ferromagnetic flux guides coupled to poles of the rotatable magnet and rotatable therewith.

17. A magnetic unit comprising:
a first magnetic component having a polarity along a longitudinal direction;
wherein the first magnetic component is configured for repeatedly applying a first pole on a first target side along the longitudinal direction and cancelling the first pole on the first target side at a frequency.

18. The magnetic unit claim 17, wherein the frequency is adjustable.

19. The magnetic unit claim 17, wherein the frequency is adjustable to increase for increasing a strength of magnetic flux applied by the magnetic apparatus to a work-piece on the first target side, and is adjustable to decrease for decreasing the strength of the magnetic flux applied by the magnetic apparatus to the work-piece.

20. The magnetic unit claim 17, wherein the frequency is adjustable for adjusting a depth of magnetic flux applied by the magnetic apparatus in a work-piece on the first target side.

21. The magnetic unit claim 17, wherein the frequency is adjustable to increase for decreasing a depth of magnetic flux applied by the magnetic apparatus in a work-piece, and is adjustable to decrease for increasing the depth of the magnetic flux applied by the magnetic apparatus to the work-piece.

22. The magnetic unit of any one of claims 17 to 21, wherein the first magnetic component is configured for repeatedly switching the first pole and a second pole on the first target side at the frequency, the second pole being opposite to the first pole.

23. The magnetic unit of claim 22, wherein the first magnetic component is also configured for repeatedly switching the first pole and a second pole on a second target side at the frequency, the second target side being opposite to the first target side.

24. The magnetic unit of any one of claims 17 to 23 further comprising:
a second magnetic component on a lateral side of the first magnetic component;
wherein a polarity of the second magnetic component is aligned with a polarity of the first magnetic component when the first pole is applied on the first target side.

25. The magnetic unit of any one of claims 17 to 24, wherein the first magnetic component is rotatable for repeatedly apply the first pole on the first target side and cancelling the first pole on the first target side at the frequency.

26. The magnetic unit of any one of claims 17 to 25 further comprising:
a driving component for driving the first magnetic component to repeatedly apply the first pole on the first target side and cancelling the first pole on the first target side at the frequency.

27. The magnetic unit of claim 26, wherein the first magnetic component comprises a permanent magnet; and
wherein the driving component is configured for rotating the first magnetic component to repeatedly apply the first pole on the first target side and cancelling the first pole on the first target side at the frequency.

28. The magnetic unit of claim 26 dependent from any one of claims 17 to 24, wherein the first magnetic component comprises an electromagnetic structure; and
wherein the driving component is configured for applying an alternating current to the electromagnetic structure to repeatedly apply the first pole on the first target side and cancelling the first pole on the first target side at the frequency.

29. A magnetic unit comprising:
one or more magnetic components switchable between an ON state and an OFF state;
wherein the one or more magnetic components in the ON state are configured for applying a magnetic field on a target side thereof;
wherein the one or more magnetic components in the OFF state are configured for cancelling the magnetic field on the target side thereof; and
wherein the one or more magnetic components are configured for repeatedly switching between the ON state and the OFF state at a frequency.

30. A magnetic apparatus comprising:
one or more magnetic units of any one of claims 1 to 29.

31. A magnetic apparatus comprising:
a first magnetic unit for forming the first pole; and
a second magnetic unit spaced apart from the first magnetic apparatus for forming a second pole opposite to the first pole;
wherein at least one of the first and second magnetic apparatus is the magnetic apparatus of any one of claims 1 to 11.

32. The magnetic apparatus of claim 31 further comprising:
at least one second ferromagnetic component connecting the first and second magnetic units.
